(19) United States
(12) Patent Application Publication
(10) Pub. No.: US 2004/0260577 A1
(43) Pub. Date: Dec. 23, 2004

(54) Electronic healthcare information and delivery management system with an integrated medical search architecture and capability

(75) Inventors: Michael Dahlin, Austin, TX (US); Randolph Lipscher, Austin, TX (US)

Correspondence Address: TOLER & LARSON & ABEL L.L.P., 5000 PLAZA ON THE LAKE STE 265, AUSTIN, TX, 78746, US

(73) Assignee: RECARE, Inc.

(21) Appl. No.: 10/723,991

(22) Filed: Nov. 26, 2003

Related U.S. Application Data
(63) Continuation-in-part of application No. 09/440,557, filed on Nov. 15, 1999.
(60) Provisional application No. 60/430,453, filed on Dec. 3, 2002.

(51) Int. Cl. G06F 17/60

(52) U.S. Cl. 705/2

(57) ABSTRACT

The disclosure is directed to computer-implemented method for integrating information into a medical workflow process. The method includes receiving data associated with a patient, initiating a computer search of information based on the received data associated with the patient, receiving search results from the computer search of information, and integrating the search results into the medical workflow process.

### CROSS-REFERENCE TO RELATED APPLICATION(S)

The present application claims priority to U.S. patent application Ser. No. 09/440,557, filed on Nov. 15, 1999 and entitled “Electronic Healthcare Information and Delivery Management System,” which is incorporated by reference herein in its entirety.

The present application claims priority to U.S. Provisional Patent Application No. 60/430,453, filed on Dec. 3, 2002 and entitled “Electronic Healthcare Information and Delivery Management System with integrated medical search architecture and capabilities,” which is incorporated by reference herein in its entirety.

### TECHNICAL FIELD

The disclosure relates generally to health care information and delivery services. More particularly, the disclosure relates to a system and method for integrating information into a medical workflow process.

### BACKGROUND

Improved efficiency, accuracy, and service have been consistently desired in the healthcare industry. Beginning in the early 1980s, the concept of a computerized patient record (CPR), also called an electronic medical record (EMR), began to receive attention from software development companies. Several software products were created to streamline the practice of medicine. These products included software for creating and storing medical records, writing and transmitting prescriptions, ordering and reviewing lab tests, verifying insurance coverage and billing of services.

Attempts at solving these problems involve computer software and hardware systems that are desktop or laptop computer based or handheld physician practice tools. Physicians do not practice medicine while sitting in front of a desktop or laptop computer. Physicians are long accustomed to moving from patient to patient, room to room, creating the medical record on clipboards as they go, writing prescriptions on small pads they can easily carry. Handheld physician practice tools include devices that are to be physically connected (“docked”) to a device or network for information to be transferred to the Internet or to a central computer. Other handheld devices rely on infrared wireless connections that force the user to point the handheld device at an infrared port on a base station, printer, or other fixed device for information to be transferred. Handheld devices often have small screens, black-and-white or grayscale displays, and poor resolution.

Physicians are not likely to respond to a new technology lacking any significant economic or timesaving benefits. They are also not responsive to technology and systems that significantly alter their established patterns of behavior.

Current systems do not offer a method for directing patient specific health care information and health care product information to physicians at specific points in a physician's work cycle, such as prescription writing or performing a physical assessment of a patient. Healthcare information is available to the physician in medical journals, but it is not presented to the physician while he or she is with a patient. Nor is it targeted to the condition and symptoms of the patient being seen by the physician. Healthcare product advertisements are also included in those journals and are separately sent to physicians. These are also not directly linked to the conditions, histories, and medications of the individual patients and may not be readily available to the physician while treating a patient.

It would be desirable to develop a new model for directing patient specific health care information and health care product information to physicians at specific points in a physician's work cycle, such as prescription writing or doing a physical assessment. The health care information and product information should be selected based on patient criteria such as the patient's age, gender, past medical history, current complaint, condition, allergies, current medications or formulary restrictions. Accordingly, there is a need for an improved electronic healthcare information and delivery management system.

### SUMMARY

In one exemplary embodiment, the disclosure is directed to computer-implemented method for integrating information into a medical workflow process. The method includes receiving data associated with a patient, initiating a computer search of information based on the received data associated with the patient, receiving search results from the computer search of information, and integrating the search results into the medical workflow process.

In another exemplary embodiment, the disclosure is directed to a system for processing information associated with patient medical data. The system includes at least one user interface for receiving patient medical data, a database storing data records associated with the patient medical data, a server having access to the database, a set of search rules accessible by the server, and a network interface accessible by the server. The server is configured to initiate a search resulting in a search result based on the data records stored in the database and the set of search rules. The server initiates the search and receiving the search result through the network interface.

In a further exemplary embodiment, the disclosure is directed to a system for receiving information associated with patient medical data. The system includes at least one user interface for receiving patient medical data, a database for storing records associated with the patient medical data, a server coupled to the database, and at least one healthcare data storage computer. The server is configured to initiate a search of the at least one healthcare data storage computer based on the patient medical data to provide a search result.

### BRIEF DESCRIPTION OF THE DRAWINGS

FIG. 1 is a functional block diagram of the health information management system.

FIGS. 2A through 2D are tables that detail the specific types of participants in the health information management system.

FIG. 3 shows the networked health information management system.

FIGS. 4A through 4G are tables that detail the types of data exchanged between the system components of the health information management system.

FIG. 5A shows the healthcare provider client computer utilizing a local area network to access the external network connection.

FIG. 5B shows client computers utilizing a local area network at the healthcare provider's facility and a proxy server to access the external network connection.

FIG. 5C shows client computers at the healthcare provider's facility connecting directly to the external network.

FIG. 5D shows client computers at the healthcare provider's facility connecting to base stations.

FIG. 6 shows an embodiment of the health information manager.

FIG. 7 is a flowchart of one embodiment of the health care provider system access process.

FIGS. 8A and 8B depict a flowchart of one embodiment of the prescription writing process.

FIG. 9 is a flowchart of the history and examination process.

FIG. 10 is an exemplary display of a patient record input screen that is suitable for use by a healthcare worker in the history and examination process.

FIG. 11 is an exemplary display of a lab results screen suitable for use by a healthcare worker.

FIG. 12 is a flowchart of the process of entering, selecting, annotating and transmitting health-related information.

FIG. 13 is a flowchart of the process of selecting, reviewing, ordering or annotating lab and other tests,

FIGS. 14A and 14B depict a flowchart of a patient's interaction with the healthcare information management system for entering patient information.

FIG. 15 is a flowchart of a patient's interaction with the healthcare information management system.

FIG. 16 is a block diagram of the function of determining the healthcare information, product information and advertisements to display.

FIGS. 17A and 17B depict a flowchart of the healthcare information manager process for selecting healthcare advertisements to be displayed after the healthcare worker enters a diagnosis of a patient.

FIG. 18A is a block diagram of the process of automatically writing a prescription for a patient.

FIG. 18B is an illustration of a screen for prescription parameters selection screen for implementing the process of FIG. 18A.

FIG. 19 is block diagram of the process of using patient-entered information and healthcare worker entered information to influence advertisement selection and display.

FIG. 20 is block diagram of the process of using patient-entered information and healthcare worker entered information to create a patient's medical record.

FIG. 21 is a block diagram of the process of merging healthcare provider or patient generated information and other healthcare information and allowing the healthcare provider to edit and annotate the information.

FIG. 22A-H is a flowchart of an exemplary interaction of a patient and a healthcare worker with the healthcare information and delivery system.

FIG. 23 is a pictorial screen diagram illustrative of a pharmacy selection screen.

FIG. 24 is a pictorial screen diagram illustrative of a selected pharmacy display screen.

FIG. 25 is a pictorial screen diagram illustrative of a pharmacy map screen.

FIG. 26 is a pictorial screen diagram illustrative of a customized screen displayed to a patient when the patient logs onto the health information management system.

FIG. 27 is a pictorial screen diagram illustrative of a customized blood pressure data input screen.

FIG. 28 is a pictorial screen diagram illustrative of a customized blood pressure results graph screen.

FIG. 29 is a pictorial screen diagram illustrative of a customized patient complaint screen.

FIG. 30 is a pictorial screen diagram illustrative of a customized complaint-specific diagnostic screen.

FIG. 31 is a pictorial display diagram illustrative of a customized prescription pad screen.

FIG. 32 is a flowchart of the process of storing refills of a prescription for future use.

FIGS. 33A and 33B depict a system diagram of the integrated medical search architecture.

FIG. 34 illustrates a partial screen view of an integrated medical search search complaints or when no relevant data were located.

FIG. 35 illustrates a partial screen view of an integrated medical search after a search completes where the data that were located are routine.

FIG. 36 illustrates a partial screen view of an integrated medical search after a search completes where the data that were located are of high priority.

### DETAILED DESCRIPTION

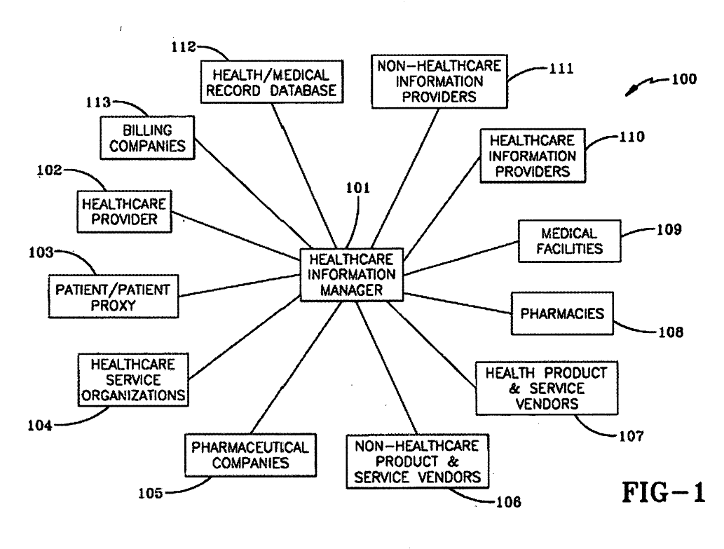

FIG. 1 is a functional block diagram of the health information management system 100. A healthcare information manger 101 coordinates the transmission and receipt of information from other participants in the health information management system 100. The participants may represent individual people, entities, or businesses. These participants include healthcare providers 102, patients or patients' proxy 103, healthcare services organizations 104, pharmaceutical companies 4 05, non-healthcare product and service vendors 106, healthcare product and service vendors 107, pharmacies 108, medical facilities 109, healthcare information providers 1 IO, non-healthcare information providers 1 II, health and medical record databases 112, and billing companies 113. A patient proxy may be a person or organization authorized to act on behalf of a patient, such as a parent for a minor patient or a guardian for an incapacitated patient.

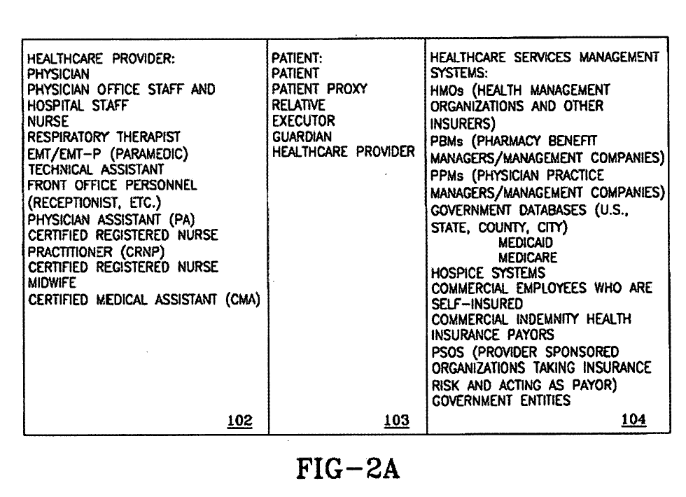

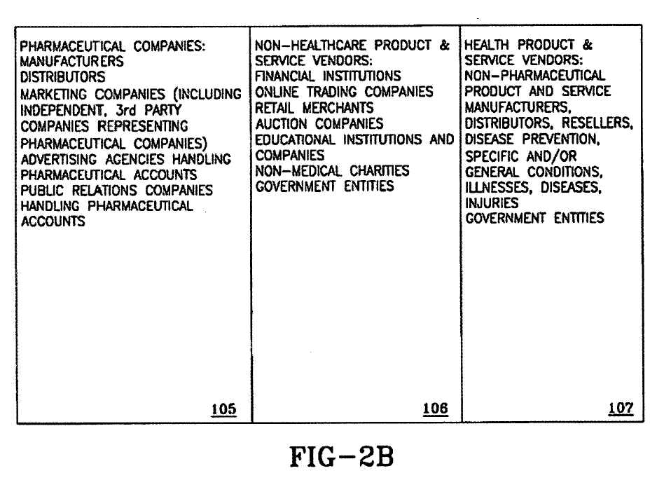

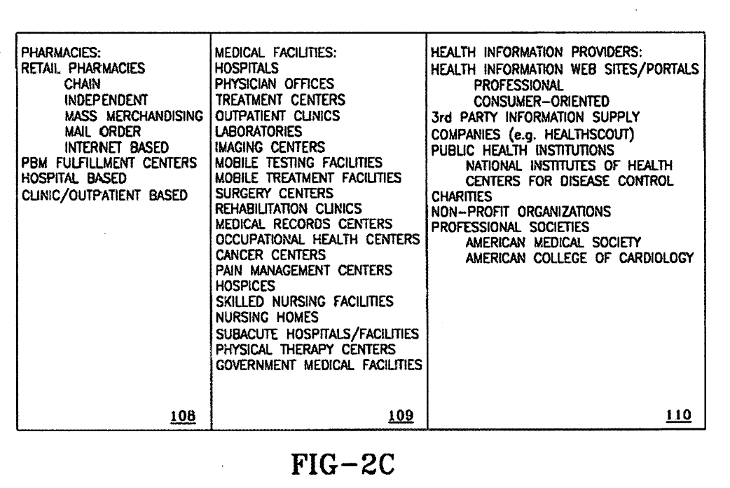

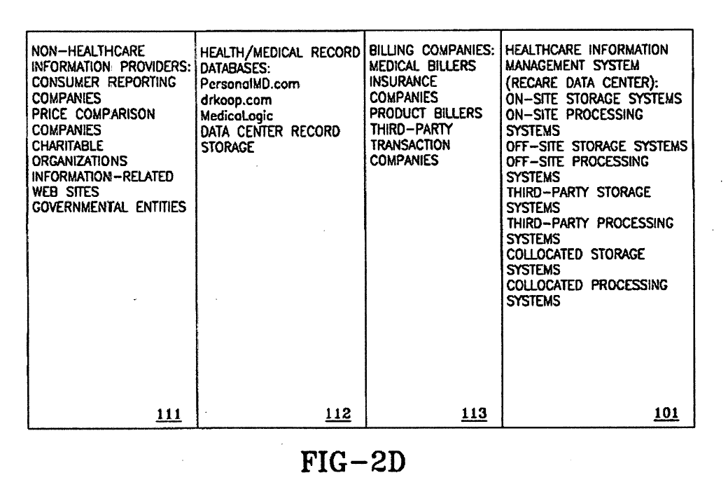

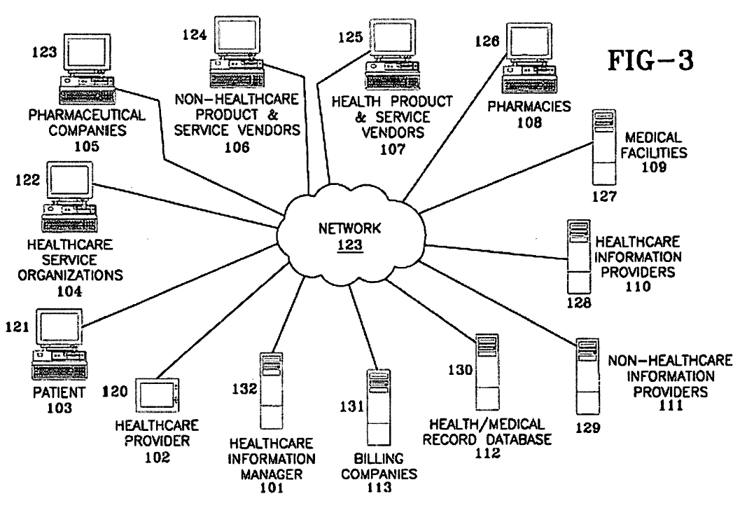

FIGS. 2A through 2D are tables that provide examples of the specific types of participants 102-I 13 in the health information management system. It is further noted that other participants not specifically listed in FIGS. 2A through 2D may be involved in some aspects of the health information management system, such as intermediary institutions.

FIG. 3 shows the networked health information management system. Each participant is equipped with a computing system 120-131 to facilitate networked communications. The patients or patients' proxy 103 and pharmacies 108 are shown using devices 121 and 126 in the form of a personal computer to connect and interact with the health care information management system, although other types of devices for interaction may be used including laptops, notebooks, handheld computers, set-top boxes, computer servers, hand-held mobile devices such as mobile personal digital assistants with Internet access or mobile phones with Internet access, wireless personal access devices, telephone combination devices and the like. When the patient is at the physician's office and wants to access the health care information management system, the patient may use a kiosk-based device or other device as listed above. The healthcare provider 102 may use a device such as a portable, wireless personal access device (PAD) that uses radio frequencies to enable to access the Internet or send and receive email within a certain number of feet of the device's base station. One such device is National Semiconductor's W&PAD™. The healthcare provider may also use any of the other devices as listed above to communicate within the networked health information management system.

The healthcare services organizations 104, pharmaceutical companies 105, non-healthcare product and service vendors 106, healthcare product and service vendors 107, medical facilities 109, healthcare information providers 110, non-healthcare information providers 111, health and medical record databases 112, and billing companies 113 and healthcare information manager 101 are shown having devices 122-125 and 127-132 for interacting with the health information management system in the form of a computer server, although other types of computing devices may be used including mainframe computers, minicomputers, a networked set of computers, personal computers, laptops, notebooks, handheld computers, set-top boxes, hand-held mobile devices such as mobile personal digital assistants with Internet access or mobile phones with Internet access, wireless personal access devices, telephone combination devices and the like. The device may be a single computer, multiple computers connected independently to a network or collections of several computers providing client services.

The devices 120-132 accept input information in many forms including keyboard, mouse, touch screen, light pen, voice recording, voice-to-text transfers and the like. The devices 120-132 are connected with each other via a data communication network 123. The network 123 may be a public or private communication network such as, but not limited to, a global communications network (commonly known as the Internet), a Wide Area Network (WAN), a Local Area Network (LAN), interactive television (In/), cable or a wireless network. For the purposes of discussion, it will be assumed that the network is embodied as the Internet. In this context, the devices 120-132 may or may not be connected to the Internet at all times. For instance, some devices may employ a modem to occasionally connect to the Internet while other units may maintain a permanent connection. In light of the importance of privacy concerns, the health care information and delivery management system employs information security such as a physically secure network, data encryption, authorization certificates, digital signatures and other techniques, or combinations of information security techniques, which are known in the network security arts.

The system can be implemented as a client-server software architecture where the computing units, comprising the healthcare providers 102, patients or patients' proxy 103, healthcare services organizations 104, pharmaceutical companies 105, non-healthcare product and service vendors 106, healthcare product and service vendors 107, pharmacies 108, medical facilities 109, healthcare information providers 110, non-healthcare information providers 111, health and medical record databases 112, and billing companies 113 are clients and the healthcare information manager 101 acts as the server. In one embodiment, the clients may be web browsers and the server may be a web server. Other implementations are possible.

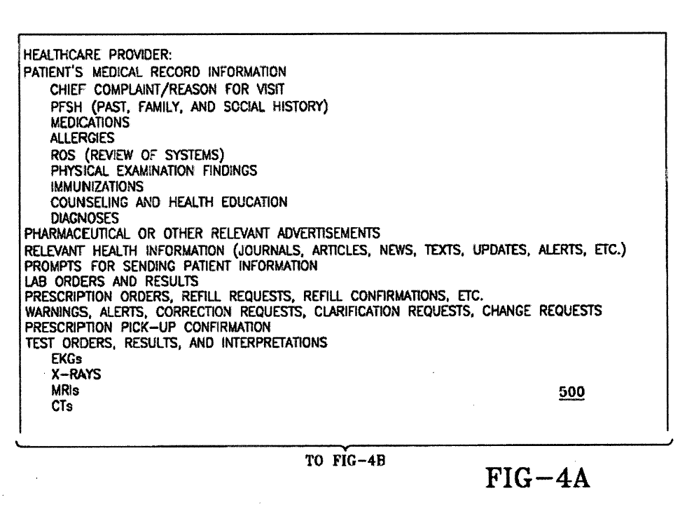

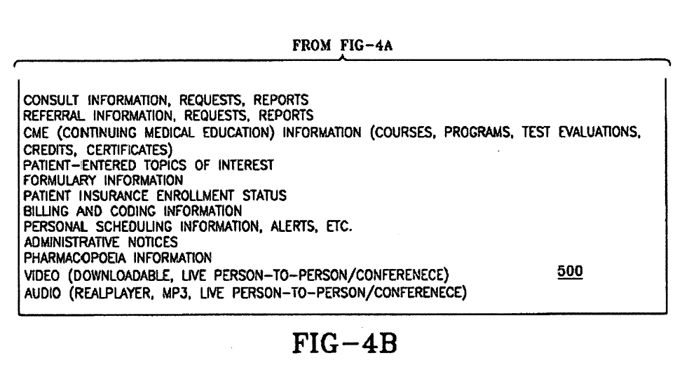

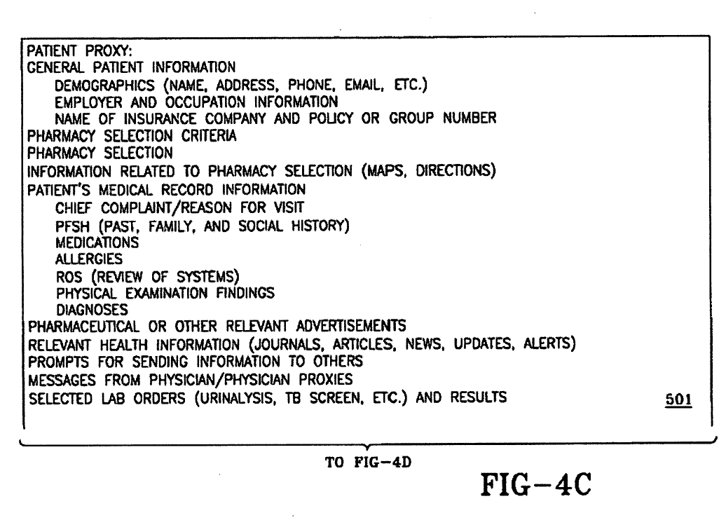

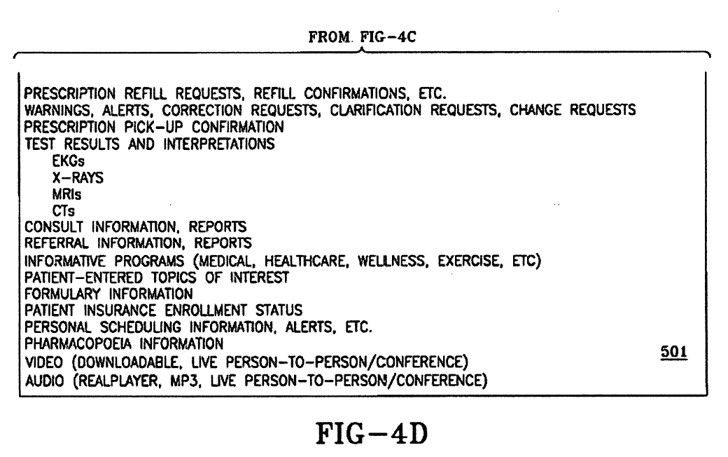

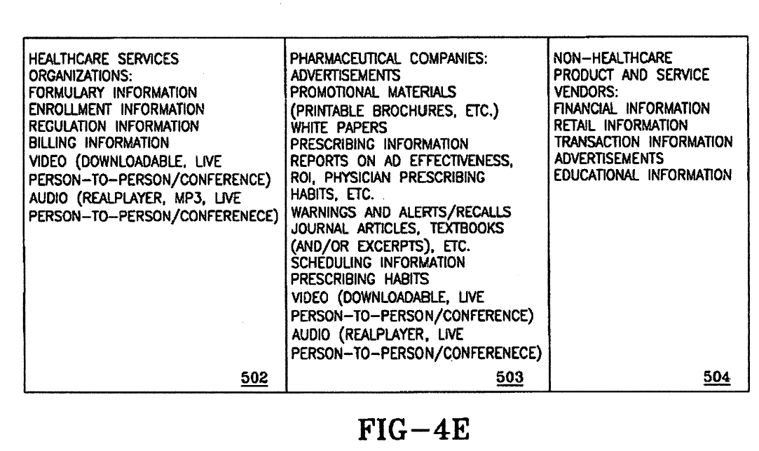

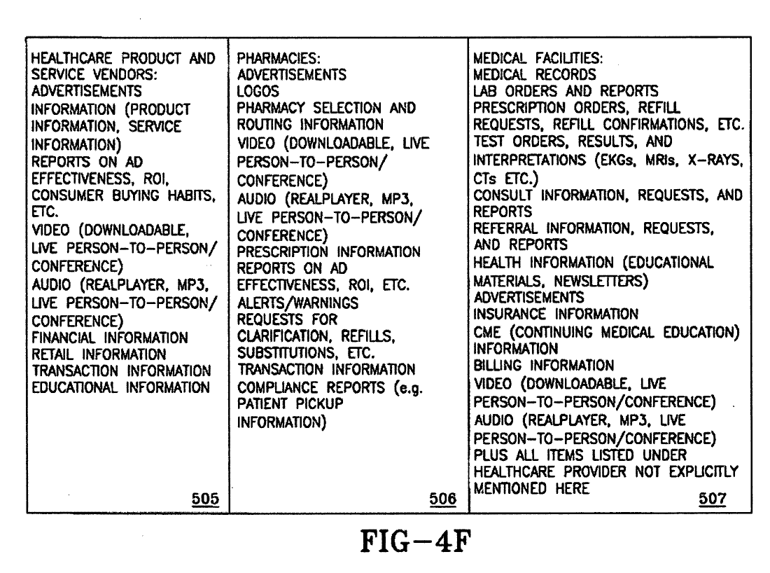

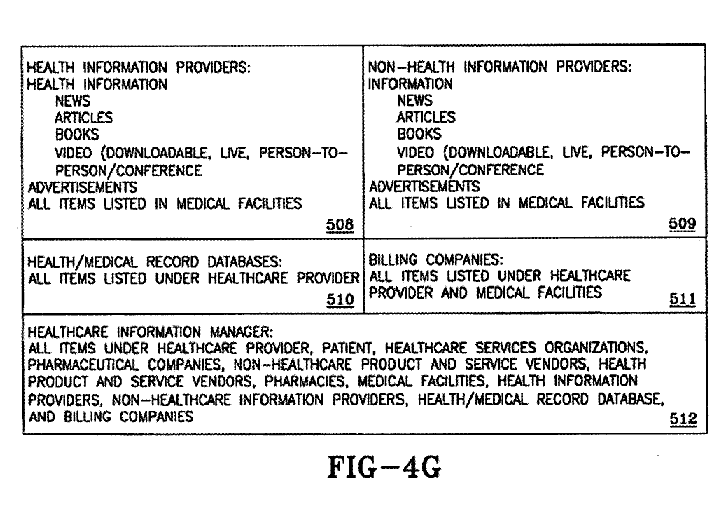

FIGS. 4A through 4G are tables that detail the types of data exchanged between the system components of the health information management system. The healthcare information manger 512 transmits data to and receives data from the other participants in the health information management system. The particular data transmitted and received by the information healthcare providers 500, patients or patients' proxy 501, healthcare services organizations 502, pharmaceutical companies 503, non-healthcare product and service vendors 504, healthcare product and service vendors 505, pharmacies 506, medical facilities 507, healthcare information providers 508, non-healthcare information providers 509, health and medical record databases 510, and billing companies 511 are listed in FIGS. 4A through 4G. In one embodiment of the system, the healthcare information manager 512 acts as the central controller of all information in the system. Other embodiments, including a distributed system model in which data is transmitted directly between other participants in the system, are possible.

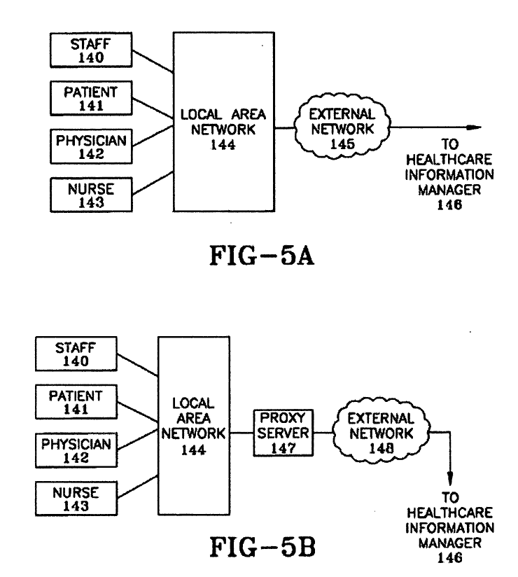

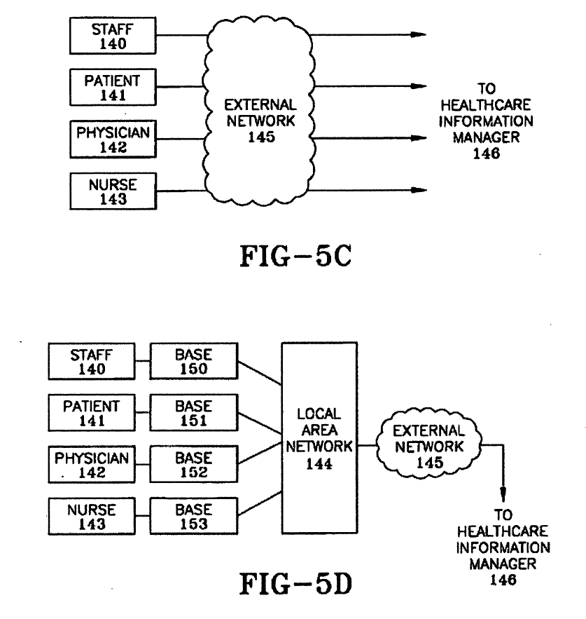

FIGS. 5A through 5D illustrate possible configurations for the healthcare provider (102 in FIGS. 1-3). These configurations can also extend to the other participants in the system.

FIG. 5A shows client computers utilizing a local area network at the healthcare provider's facility to access the external network connection. Exemplary healthcare providers such as the office staff 140, physician 142 and nurse 143 along with the patient who is visiting the healthcare provider's facility 141 are connected via a local area network 144 to an external network 145. Examples of a the local area network include an Ethernet network, a token ring network, an infrared network, radio or wireless network. The local area network may connect to the external network connection 145 via a modem, cable modem, ISDN or ADSL connection, router, gateway or switch, or other connection, which will then facilitate the connection of the client with the healthcare information manager 146.

FIG. 5B shows client computers utilizing a local area network at the healthcare provider's facility and a proxy server to access the external network. It is similar to FIG. 5A with the exception that a proxy server 147 acts as an intermediary between the client and the Internet so that the system can ensure security, administrative control, and caching service. A proxy server may be part of a gateway server that separates the client network from the outside network and a firewall server that protects the client network from outside intrusion. An advantage of a proxy server is that its cache can serve all users. If one or more Internet sites are frequently requested, these are likely to be in the proxy's cache, which will improve user response time. The server 147 may include a local database that stores data locally and is accessed for applications that employ the data. Almost any functionality that would normally be done at the main server can be done on the proxy server. The proxy server may facilitate transmission of data among devices at the healthcare center to reduce dependence on the external network so that the system will still function if a network connection fails. Typical applications that access the database in the server 147 include cross-checking of physician prescriptions with patient medications and allergies, cross checking of physician prescriptions and patient susceptibility to adverse drug interactions, determining the pharmacy benefit management company of the patient and other functionality. The server 147 selectively performs operations such as merging selected physician input data with selected patient-input data and selected staff input data, and transmits both merged and unmerged data to the external network 148 to be processed by the healthcare information manager 146. The server also provides for the generation and transmission of dynamic data such as dynamic web pages. The server can service the client computers during a failure of the network connection and provide better performance by avoiding wide area network (WAN) communication.

FIG. 5C shows client computers at the healthcare provider's facility connecting directly to the external network. The staff 140, patient 141, physician 142 and nurse 143 are connected directly to the external network 145 and then in turn to the healthcare information manager 146.

FIG. 5D shows client computers 140-143 at the healthcare provider's facility connecting to base stations 150-153 that in turn connect to a local area network 144 which connects to an external network 145 that facilitates communication between the clients 140-143 and the healthcare information manager 146 over the external network 145. This configuration is used when the client's computers are wireless devices that are connected (called docking) to a base stations 150-153 before data from the wireless devices can be transmitted or received from the health information manager 146. This configuration is also used when the device is a portable, wireless personal access device (PAD) that uses radio frequencies to enable to access the Internet or send and receive email within a certain number of feet of the device's base station and does not need to be physically connected to a base station to transmit of receive data from the network. The base station 150-153 may provide one or more of the following functionality: network connectivity, synchronization of files or records between the terminal's version and the base station's version, and generation and transmission of dynamic data such as dynamically generated web pages.

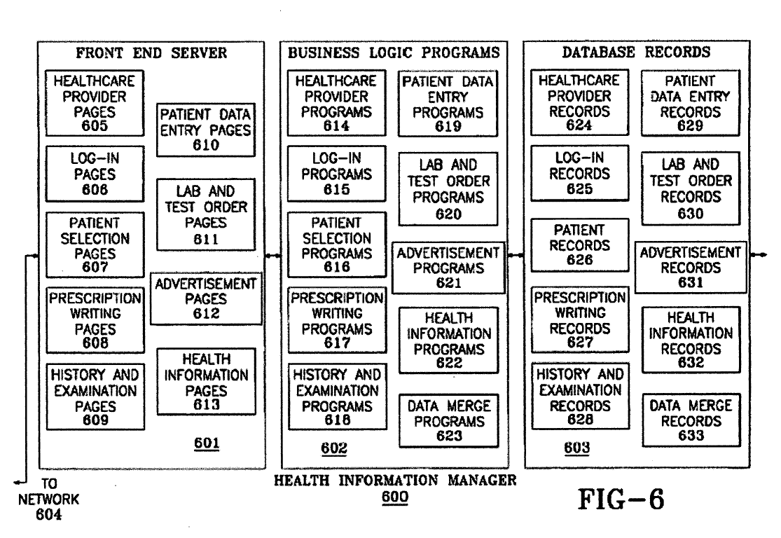

FIG. 6 shows an embodiment of the health information manager 600. In this embodiment, the health information manager 600 consists of a front-end web server 601 connected to a communications network 604 (which may be a global communications network such as the Internet, a Wide Area Network (WAN), a Local Area Network (LAN), interactive television (In/), cable or a wireless network), a set of business logic programs 602 (for example, Common Gateway Interface scripts, Active Server Pages, Java Servlets), as well as software specifically to implement the functions of the health information management system, and a database 603. Practitioners versed in the state of the art will recognize that this functionality could be implemented in several ways. One or more of these layers could be omitted, the system could distribute data using a file system, the system could use a file system for back-end data storage rather than a database, and combinations of similar techniques could be used. These logical modules may run together on a single machine, on separate machines connected by a network, or may be distributed across a collection of machines connected by a network.

In one embodiment, applications used by users of the system are implemented as a series of interconnected web pages, some of which are static and provided by the front end web server 601 and some of which are dynamically generated in response to immediate user input. The static pages include health care provider pages 605, log-in pages 606, patient selection pages 607, prescription writing pages 608, history and examination pages 609, patient data entry pages 610, lab and test order pages 611, advertisement pages 612 and health information pages 613. In this embodiment, the dynamically generated pages are created by business logic programs 602 that access the database 603. Applications of this sort include the health care provider programs 614, log-in programs 615, patient selection programs 616, prescription writing programs 617, history and examination programs 618, patient data entry programs 619, lab and test order programs 620, advertising and information selection programs 621, health information programs 622 and data merge programs 623. Other implementations are possible such as running some of these functions or parts of these functions at the client or client proxy machine. The database 603 contains stored data records used by the business logic programs 602 and the front-end server 601. The database records include health care provider records 624, log-in records 625, patient records 626, prescription writing records 627, history and examination records 628, patient data entry records 629, lab and test order and result records 630, advertisement records 631, health information records 632 and merged data records 633.

In one method of use of selecting advertising, a request arrives at a HTTP Hypertext Transfer Protocol (HTTP) front end server 601 and based on the object identified by the Uniform Resource Locator (URL) which is the address of a file resource accessible on the Internet. In the request, the front-end server 601 sends the request to the advertisement business logic program 602. The advertisement business logic program 621 reads from several of the databases 603 such as the current patient's complaint from the patient data entry records 626, the patient's smoking status from the patient data entry records or from the patient records, the doctor's specialty from the doctor or clinic relation 624, diagnosis of the patient's illness from the patient records 626, the patient's current list of medications from prescription writing 627 or patient records 626, medications allowed by an insurance formulary from health information records 632 and target markets for advertisements from the advertisement records 631. Based on such factors, the advertising selection program 621 chooses an advertisement to display and directs the front-end sewer 601 to transmit that advertisement page to a remote machine through the communications network 604. For example, when a request for an advertisement arrives through the communications network 604 from a machine being used by a cardiologist that is working with a particular patient, the advertisement program 621 could decide whether to display an advertisement for a smoking cessation product by querying the patient's database records to determine if the patient smokes, then querying the physician's record 624 of what smoking cessation products the doctor has prescribed to patients or sent information about to patients in the past, and finally querying the advertising database 631 to find smoking cessation advertisements. In another example, when a general practitioner uses the system while examining a patient complaining of allergies, the advertising selection program 621 would query the doctor's past prescribing habits 624 and 627, the patient's insurance coverage 626, current medications and allergies 626 and 627, and the advertising database 631 to select from among allergy medications to advertise based on payments by different advertisers to target specific combinations of doctor and patient characteristics.

In this figure, the subcomponents (records) of the database 603 represent different logical groupings of data relevant to the system. For example, the healthcare provider records 624 could be implemented as a set of relations keyed by clinic ID that lists for each clinic, the clinic's name, list of doctors at the clinic, list of patients of the clinic, clinic address, clinic phone number, clinic fax number, security and network information to access the clinic's printer, patients currently signed in at the clinic, and account information used by clinic staff to update the clinic records. Additional healthcare provider relations keyed by staff identification numbers provide storage and access to records regarding individual staff members such as doctors, nurses, technicians, and administrative staff at a clinic. Such information could include the name of the staff person, title of the staff person, Drug Enforcement Administration ID of the staff person, a log of past actions by the staff person (such as prescriptions written, patients seen, topics of interest, and the like). The log-in records 625 include records keyed by user IDS with records of user passwords or security keys. The patient records and patient data entry records 626 and 629 are records keyed by patient ID mapping to information including patient complaint, patient long-term conditions, patient smoking status, patient gender, patient visits, patient interests in topics, and the like. The prescription writing records 627 are records keyed by prescription ID with information such as the medication prescribed, dosage, frequency, prescribing doctor, patient, etc. The history and examination records 628 are keyed by visit ID and include information such as the doctor, clinic, patient, prescriptions, primary complaint, record of the history of current illness, a list of labs and tests ordered, record of the physical examination, record of the diagnosis, and the like. The lab and test order and result records 629 are indexed by test identification and list for each exam the visit ID, the name of the test, the result of the test, parameters for the test. The advertisement records 631 comprise advertised products, restrictions and other data necessary to be able to display a targeted advertisement to the user. The health information records 632 contain health information collected from a variety of sources. The merged data records 633 contain information from various sources that have been merged together, for example patient entered data may be merged with patient record data and with healthcare worker data. It can also include prescription information and pharmacy selection information. Different groupings and components are, of course, also possible.

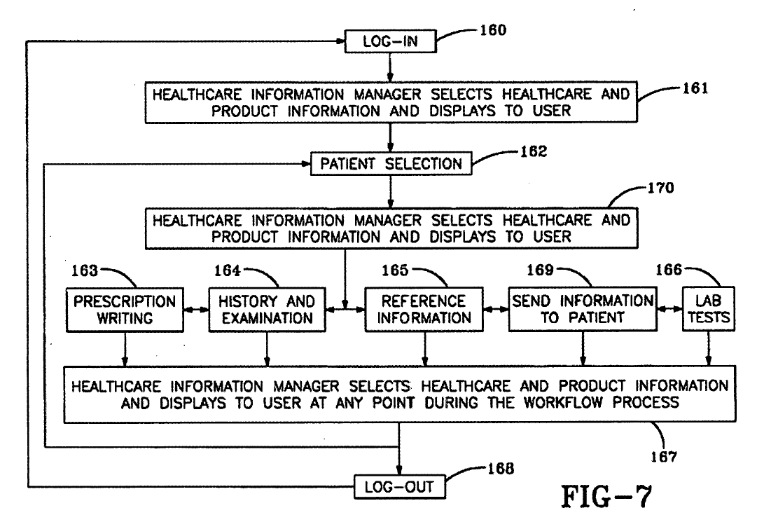

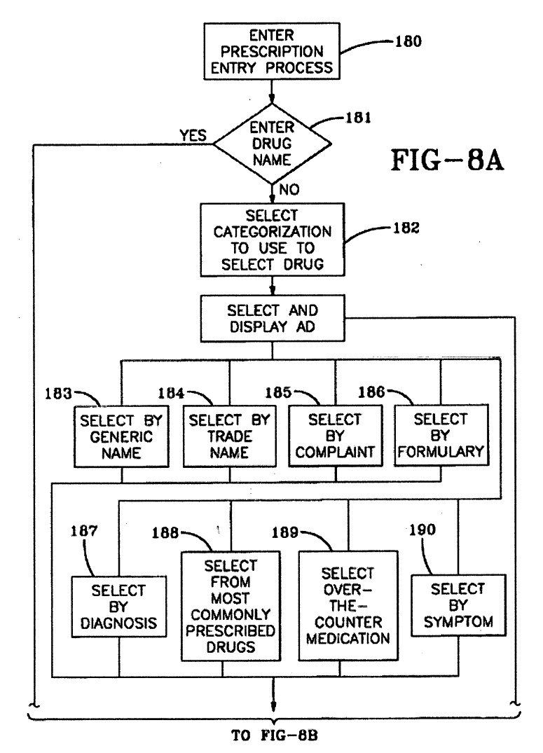

FIG. 7 is a flowchart of one embodiment of the health care provider system access process. In this embodiment, a health care worker logs in 160 and the health information manager function selects health and product information and displays that information to the user 161. The health care worker selects a patient with whom to work 162 and the health information manager function selects health and product information for display to the user. The healthcare worker can then access one or more specific health information management applications such as prescription writing 163, history and examination 164, reference information 165, sending information to a patient 169, and ordering/accessing lab tests 166. The health information manager function selects the health care and product information to be displayed to the user based depending upon a number of factors. The health care worker then returns to the patient selection process 162 or if completed, logs out 168.

At each stage in the process, healthcare information and product information (such as advertisements) related to the healthcare worker, the patient being considered, and/or the specific point in the work process may be presented to the healthcare worker. As additional information about the patient is gathered by the system, the system (in the health information manager function) may use this additional information to select and display new healthcare information and products.

The log-in process 160 gathers identification and authentication information about the health care worker such as the worker's name, the clinic at which the worker is located, the worker's password, information from the worker's smart card, biometrics identification or authentication information, etc. The result of this step is that the worker is identified to the system. The system may display healthcare and product information, including advertisements, based on factors such as the healthcare worker's or health facility's specialty 161. For example, the system may display different information to a worker in a geriatric clinic than to a worker in a pediatric clinic.

The patient selection process 162 allows the health care worker to select a patient that will be the subject of the work process. The patient selection process 162 may be implemented in one or more of several embodiments including automatic transmission of the name and record of the next patient a doctor will see to the doctor's terminal, providing a list of the doctor's patients from which to select, providing a list of patients in the clinic from which to select, providing a list of the doctor's patients in the clinic from which to select, text entry, voice entry, or other means. The system may display healthcare and product information, including advertising, to the user based on factors such as the patient's complaint, patient's history, and/or the healthcare worker's specialty. For example, if the patient smokes the system might display an advertisement for a nicotine patch. In another example, if the patient has high blood pressure, the system displays advertisements for hypertension medication. Practitioners versed in the state of the art will recognize that this figure illustrates just one of several possible embodiments of the health care worker data access and information display process; for example, other applications may be added or patient selection may be omitted in some cases.

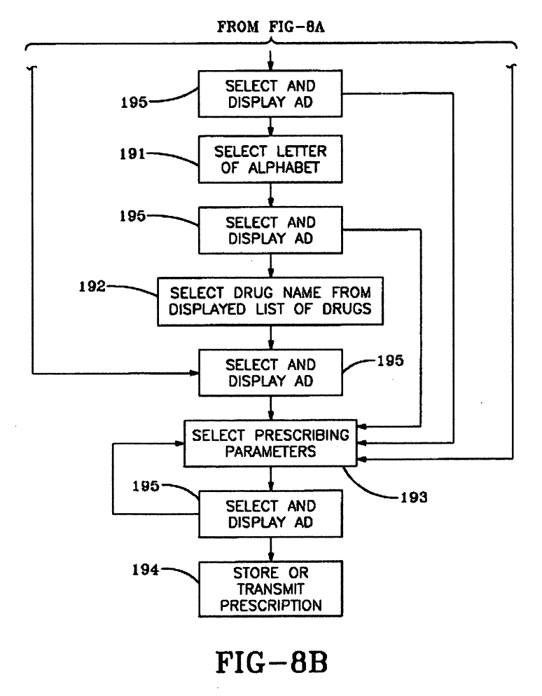

FIGS. 8A and 8B depict a flowchart of one embodiment of the prescription writing process. The prescription writing process allows a healthcare provider to assemble or select a prescription for the patient. In this embodiment, the healthcare worker may select a drug to be prescribed by one of several means including by entering the drug's name directly (e.g., by text or voice input), by navigating a series of menus or screens, or by selecting a currently-displayed advertisement at any point in the process. During this process the system may display healthcare and product information including one or more advertisements based on information the system has obtained about the patient, the doctor, or both. For example, the system might display an advertisement for an allergy medication when the doctor begins prescribing a medication for a patient complaining of allergies.

The healthcare worker enters the prescription entry process 180. If the healthcare worker chooses to enter the drug name directly 181, the system proceeds to display the prescribing parameters for selection 193.

In another embodiment, for any of the selection strategies 183 through 190, the system may go directly to displaying a list of drugs 192, skipping the alphabetical selection 191.

If the drug name is not entered directly 181) the selection through navigation of menus or screens is chosen 182 and the healthcare worker then chooses the preferred method for selecting the prescription. The options include selecting the prescription by using the generic name 183 or trade name 184 of the drug, the patient's complaint 185, the formulary selected 186, the diagnosis for the patient's condition 187, the most commonly prescribed drugs (in general, or based on physician's prescribing history) 188, over-the-counter drugs 189, or the patient's symptom 190. If one of these options is selected 183-190, the system may then display a list of letters of the alphabet and the healthcare worker may choose one of these letters 191. The system then displays a list of drugs from the selected category beginning with the selected letter and the healthcare worker may select one or more drugs from this list 191. The healthcare worker may also directly select from a list of drugs. Alternatively, if the formulary or most commonly prescribed drugs are selected, the system may directly display a list of drugs appropriate for the complaint or a list of drugs appropriate for the diagnosis 192. If one of these names is selected, the system proceeds to the prescribing parameters selection 193. At each of these steps, the system may display one or more advertisements 195 selected on the basis of information the system has obtained about the patient, doctor, or both in addition to information regarding the current location or step in the drug selection process. For example, the system might display an advertisement suggesting a particular blood pressure medication when a doctor is seeing a patient that is complaining of headaches enters a blood pressure that is high.

At any point in the process, the healthcare worker may select a currently displayed advertisement 195 causing the system to proceed to the select prescribing parameters step 193.

In the prescribing parameters selection step 193, the system allows the healthcare worker to select parameters for the administration of a medication such as the dosage, frequency, form, and duration. The system may also complete one or more of those prescribing parameters (dosage, form) based on information obtained about the patient such as weight, gender, current medications, and the like. In one embodiment, the system displays a form with selectable options for each parameter and initializes the selection to values likely to be appropriate for the patient based on information about the drug, information about the patient's condition (e.g., acute pain v. chronic pain), information about the patient (e.g., weight, age, gender, etc.). After selecting appropriate parameters, the healthcare provider may select options to store or transmit the prescription. During this stage, the system may display an advertisement based on information about the patient, information about the doctor, and information about the drug being prescribed. For example, the system might display an advertisement for an alternative drug that may be appropriate for the patient than the drug being considered or prescribed. The prescription is then stored to be printed out by the system or electronically transmitted to a pharmacy 194.

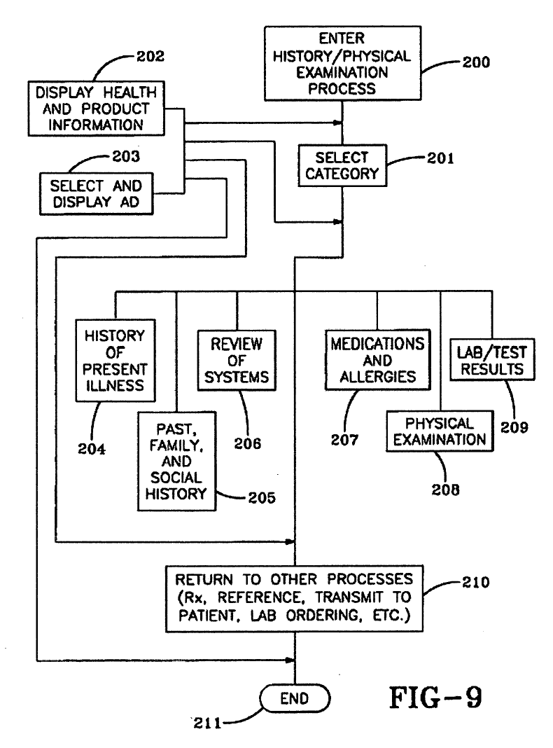

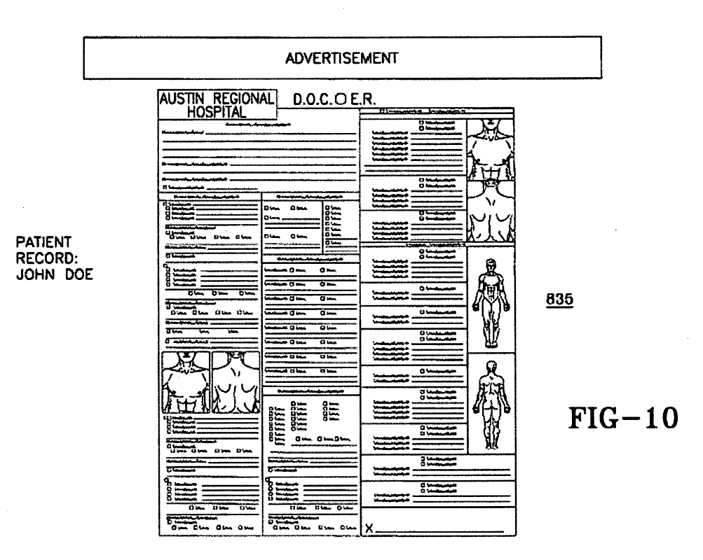

FIG. 9 is a flowchart of the history and examination process. The history and examination process 200 allows a healthcare worker to review information about the patient entered by the healthcare worker, patient, or other entity at some previous time and for the healthcare worker to edit this information or add new information to the patient's medical record. FIG. 10 is an exemplary display of a patient record input screen that is suitable for use by a healthcare worker in the history and examination process. The healthcare worker selects the particular category 201 which may include one or more of the following:

a history of present illness information such as a patient's description of his/her chief complaint, source of referral, location of condition, quality of condition, quantity of condition, timing of condition, settings of occurrence of condition, aggravating factors, associated symptoms, and the like 204;

past, family, and social history information such as general health, childhood illnesses, adult illnesses, psychological conditions, current illnesses, past injuries, past surgeries, past procedures, post hospitalizations, family medical history, smoking habits, drinking habits, drug habits, exercise habits, eating habits, current medications, allergies, work environment hazards, genetic information, general constitution, and the like 205;

a review of systems information such as information about the neurological system, ear, nose, and throat, head, respiratory system, cardiovascular system, genitourinary system, gastrointestinal system, endocrine system, integumentary system, musculo-skeletal system, and the like 206;

a list of the current medications prescribed for the patient along with the patient's allergies to medication, if any 207;

physical examination information related to the above systems 208; and

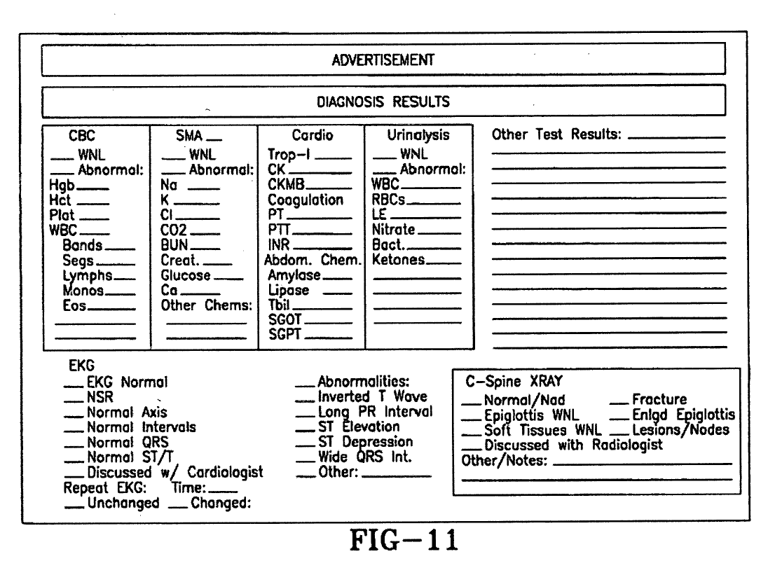

laboratory and test results 209. FIG. 11 is an exemplary display of a lab results screen suitable for use by a healthcare worker.

Turning back to FIG. 9, in one embodiment, this information 204-209 is presented to the healthcare worker in a series of forms displayed using a graphical user interface where common choices are presented to the healthcare worker from which the healthcare worker may select particular items and where additional information may be added in free text or voice format. At all steps in the process, health and product information 202 and advertisements 203 may be displayed on the graphical user interface. The system may update health and product information 202 and advertisements 203 displayed as more information is entered about the patient. For example, if the patient initially complains of a sore throat and the healthcare worker actually finds throat cancer, the system might first show advertisements for over-the-counter throat lozenges and later show advertisements for a new anti-cancer drug based on the new information the healthcare worker entered about the patient. The health and product information and advertisements 202 can be displayed at any time during the workflow process based on any piece or pieces of information gathered about the current patient and/or encounter. After completing the history and physical examination process, the program may return to other processes such as prescription writing, reference, transmitting information to a patient, lab ordering or the like 210 or the process ends 21.

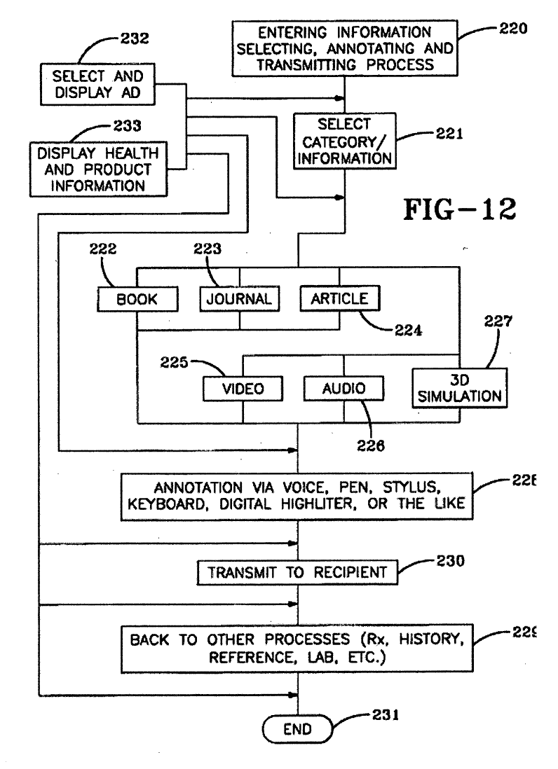

FIG. 12 is a flowchart of the process of entering, selecting, annotating and transmitting health related information from a sender (in this case a healthcare worker) to a recipient 220. The recipient may be a patient or another physician or the like. Using a GUI displayed on a computer screen, the user, a healthcare worker, selects the category or information to be transmitted 221. Information may include books 222, journal references 223, health articles 224, information on video 225, audio information 226 or a 3D simulation 227. The healthcare worker may annotate the information 228 and the information is transmitted to the recipient 230. At all steps in the process, health and product information 233 and advertisements 232 may be displayed on the graphical user interface. The system-may update health and product information 233 and advertisements 232 displayed as more information is entered about the patient. After the information entry process, the program may return to other processes such as prescription writing, transmitting information to a patient, lab ordering or the like 229 or the process ends 231.

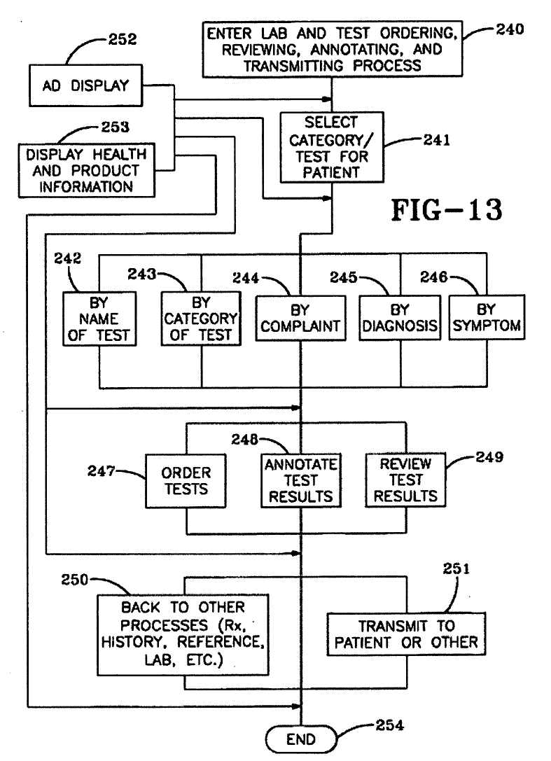

FIG. 13 is a flowchart of the process of selecting, reviewing, ordering or annotating and transmitting lab and other tests 240. Using a GUI displayed on a computer screen, the user, a healthcare worker, selects the category or test for a patient 241. The healthcare worker can select by the name of the test 242, the category of the test 243, the patient's complaint 244, the patient's diagnosis 245, and the patient's symptom 246. The healthcare worker can make the selection using the keyboard or the point and click device of computer unit, or by using voice or other. The healthcare worker can then order the test 247, annotate the test results 248 or review the test results 249. At all steps in the process, health and product information 253 and advertisements 252 may be displayed on the graphical user interface. The system may update health and product information 253 and advertisements 252 displayed as more information is entered about the patient. The ordered test 247 may be transmitted to the laboratory for completion 251, the annotated test 248 and the test results 249 may be transmitted to the patient or to another healthcare entity 251 or organization. The program may return to other processes such as prescription writing, reference, transmitting information to a patient, lab ordering or the like 250 or the process ends 254.

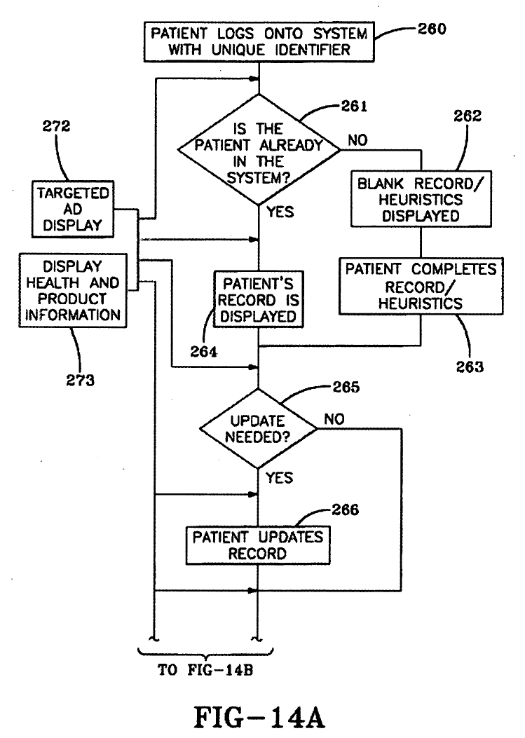

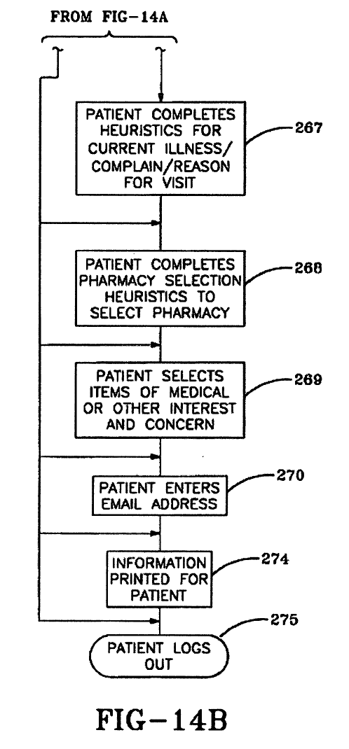

FIGS. 14A and 14B depict a flowchart of the patient's interaction with healthcare information management system for entering patient information. The patient may enter the information using a display interface of a personal computer, a laptop notebook, an Internet-enable appliance or other type of electronic device. The patient may also enter the information using a computer contained in a kiosk in the physician's office. Alternatively, the patient may provide this information to a healthcare worker in the physician's office and the healthcare worker may then enter the information in the same way as the patient in steps 261 through 270. The patient logs onto the system with a unique identifier 260. If the patient is not already in the system (a new patient), a blank record and heuristic form is displayed 262 and the patient completes the record and heuristic 263. If the patient is already in the system, the patient's record for selected portions are displayed 264 (or selected portions of the patient's record). If an update is needed 265, the patient is prompted to update the record 266. The patient completes heuristics for the current illness complaint or reason for the office visit 267. The patient completes pharmacy selection heuristics to select a preferred pharmacy 268. The patient may also select items of medical or other interest and concern 269. The patient enters his or her email address, if one exists 270. At all steps in the process, health and product information 273 and advertisements 272 may be displayed on the graphical user interface displayed to the user. The system may update health and product information 273 and advertisements 272 displayed as more information is entered about the patient. Optionally, the system may print out the information entered so it may be reviewed by the patient for accuracy 274. After the patient has completed entering information, the process ends 275.

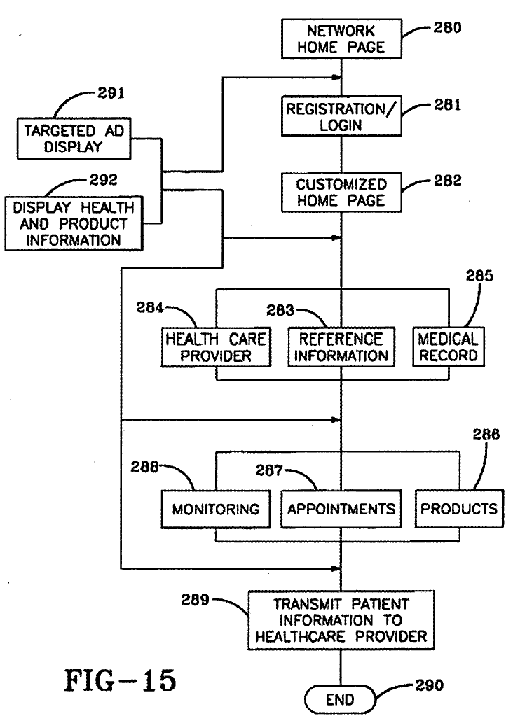

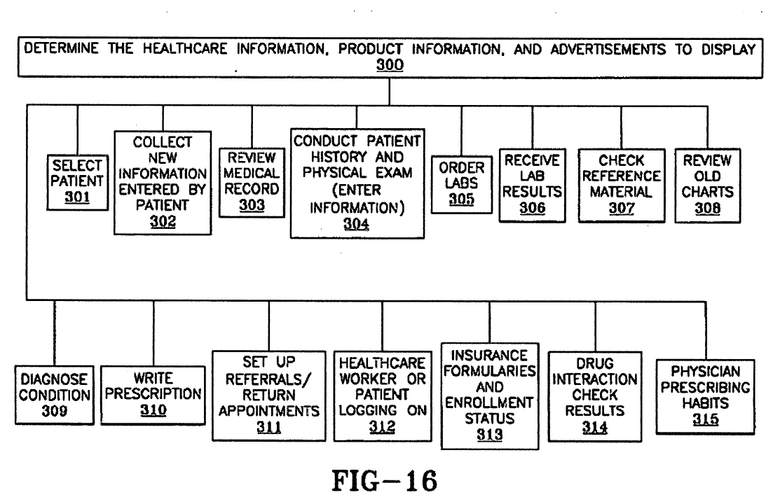

FIG. 15 is a flowchart of a patient's interaction with healthcare information management and delivery system whereby the patient accesses the system using a global communications network. The patient logs onto the healthcare information management and delivery system by selecting the healthcare information management and delivery system network home page 280. To access the home page, the patient can use any type of network access device capable of accessing the network such as a computer, video receiver, audio receiver, web pad, or the like. The patient logs onto the network home page, registers onto the system via password, biometrics, smartcard, or the like 281. The registration/login process gathers identification and authentication information about the patient and authenticates the user prior to granting access and/or displaying the patient's medical information. Once logged on and registered, the patient may access one or more specific applications or information displays. Upon logging on and registering, a home page customized for the patient may be displayed 282. In another embodiment, the patient logs directly onto the customized home page and accesses one or more specific applications and information displays or the like. The customized home page may include reference information 283 about a disease of the patient, healthcare provider information 284, the patient's medical record 285, product information in general and products for a certain condition of the patient 286 or appointments with the patient's physician 287. Remote monitoring of patient physiological data by the healthcare provider may be possible using the customized home page 288. For example, if the patient has diabetes, the patient may enter in glucose information daily to be monitored by the healthcare provider. In another example, if the patient has high blood pressure, the patient may enter in their blood pressure daily to be monitored by the healthcare provider. The information entered by the patient is transmitted to the healthcare provider through the global communications network 289 and the patient logs out 290. At all steps in the process, health and product information 292 and advertisements 291 may be displayed on the graphical user interface displayed to the user. The system may update health and product information 292 and advertisements 291 displayed as more information is entered about the patient. As additional information about the patient is gathered by the system, the system may use this additional information to select and display new advertisements.

FIG. 16 is a block diagram of the function of determining the healthcare information, product information and advertisements to display. The logic for controlling the function of determining and displaying the information and advertisements is located in the healthcare information manager (101 in FIG. 1). The healthcare information manager, at all steps in the data entry and information review processes, determines the health and product information and advertisements 300 that may be displayed on the graphical user interface to the user. The user may be anyone authorized to log onto and view the healthcare information management and delivery system, but will usually be a healthcare worker or a patient. The system may update health and product information and advertisements 300 displayed as more information is entered about the patient. As additional information about the patient is gathered by the system, the system may use this additional information to select and display new advertisements. The steps in the process where the healthcare information manager makes the decision to determine if new advertisements and/or product information is to be displayed include, but are not limited to: selecting a patient 301, collecting new information entered by a patient 302, reviewing medical records 303, conducting a patient history and physical examination 304, ordering lab work 305, receiving lab results 306, checking reference material 307, reviewing old charts 308, diagnosing the patient's condition 309, writing a prescription 310 and setting up physician referrals and return appointments 3; 1, a healthcare worker or patient logging on to the system, insurance formularies and enrollment status 313, drug interaction check results 314 and information about physician prescribing habits 315.

The healthcare information manager can use every healthcare worker action, choice, and location within the work cycle, to determine the health and product information and advertisements 300 to be displayed. Likewise, the health information manager can use patient information and patient actions and entry to determine the health and product information and advertisements 300 to be displayed.

For example, once a physician logs onto the system, the logic for controlling the function of determining and displaying the information and advertisements in the healthcare information manager can display information and advertisements relevant to his or her medical specialty. When the physician selects his or her next patient, the logic can display information and advertisements relevant to the patient's chronic conditions (such as diabetes, hypertension, and the like). When the physician enters a diagnosis, the logic can display information and advertisements for products indicated for the selected diagnosis. In another example, when the physician searches the drug database for a particular drug, information and advertisements relevant to the physician's search based on factors such as the patient's complaint and the letter under which the physician is searching for a drug in an alphabetical list can be displayed. Other types of information used to determine healthcare information and advertisements displayed include the patient's past record, insurance formularies and patient enrollment status, drug interaction check results, physician's prescribing habits and the patient's gender, weight, age, allergies, current medications, and the like.

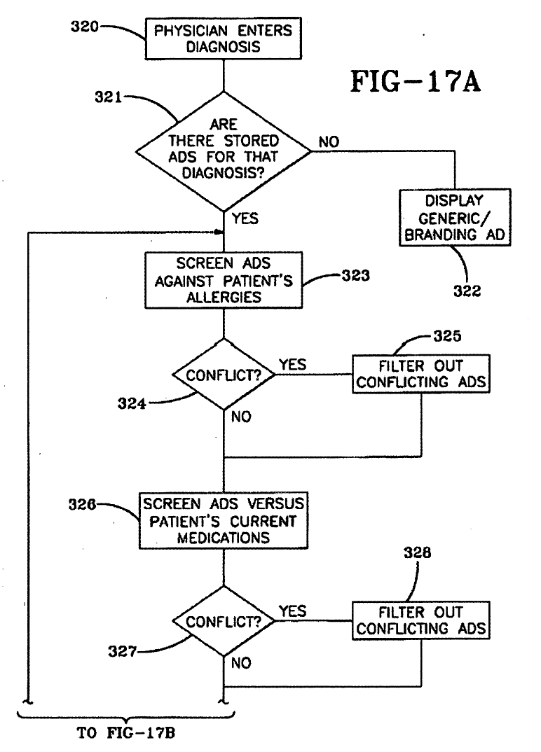

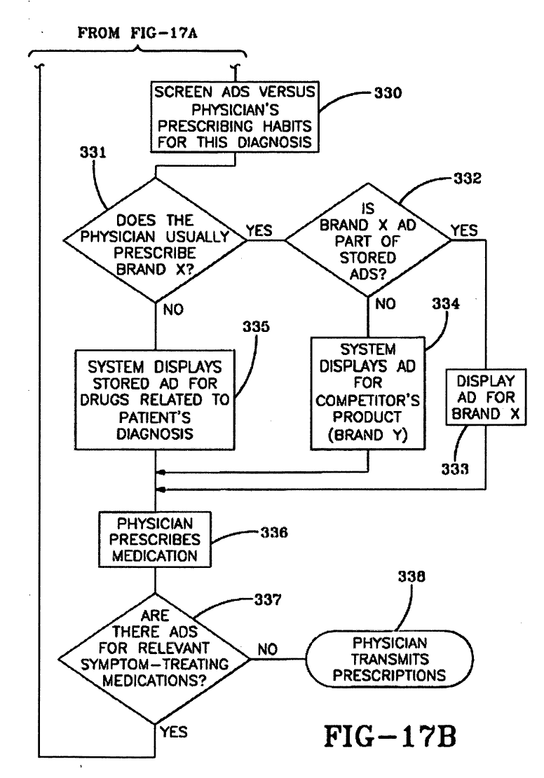

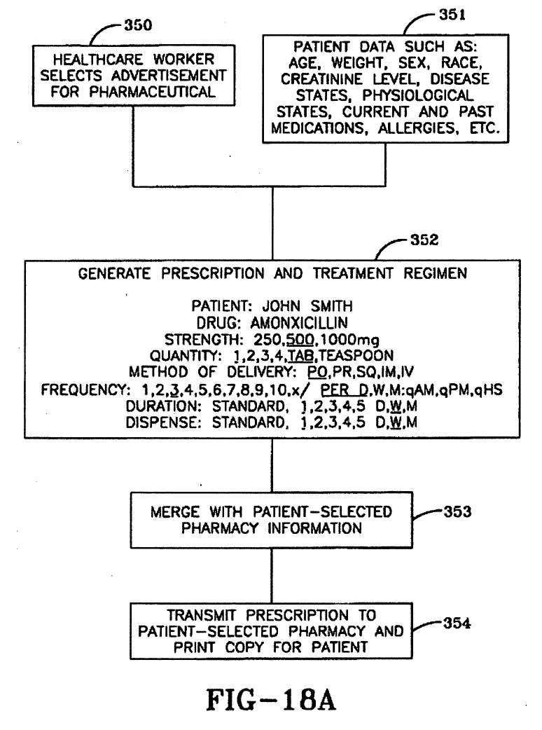

FIGS. 17A and 17B depict a flowchart of the healthcare information manager process for selecting healthcare advertisements to be displayed after the healthcare worker enters a diagnosis of a patient. The healthcare worker, in this case a physician, enters a patient diagnosis 320. If there are no stored advertisements available for this diagnosis 321, the system displays a generic advertisement 322. If there are stored advertisements available for this diagnosis 321 which include prescription drugs used for treating the medical condition, the advertisements for those prescription drugs are screened against a list of patient's allergies 323. If the patient is allergic to one or more of the prescription drugs indicating a conflict 324, the advertisements for the conflicting drugs are filtered 325. Filtering an advertisement may disqualify the advertisements so that it will not be displayed, reduce the probability that the advertisement will be displayed, select a related advertisement for display, attach a warning messaged that will be displayed along with the advertisement or take some other appropriate action. In either case 324, the advertisements are screened against the patient's current medications 326. If the there is a conflict between the patient's current medications and the advertisements for the prescription drugs used to treat the patient's condition 327, the advertisements for the conflicting drugs are filtered 328. In either case, the advertisements are screened against the physician's prescribing habits for the patient's diagnosis 330. If the physician usually prescribes a certain brand 331 (called Brand X) and Brand X is included as one of the stored advertisements 332, the system can display the advertisement for Brand X 333. If Brand X is not included as one of the selected advertisements 332 or if a competitor has purchased an advertisement, the system displays an advertisement Brand Y 334. If the physician does not usually prescribes Brand X 331, the system displays the stored advertisement(s) that most closely fits with the patient's diagnosis, allergies, current medication and physician's prescribing habits for this diagnosis 335 or a competitors advertisement. The physician then prescribes the medication 336. The physician may choose to select one of the advertised medications or not 336. If there are additional stored advertisements for relevant symptom treating medications 337, the process is repeated at step 323. Otherwise, the physician transmits the prescriptions 338 to a pharmacy for filling.

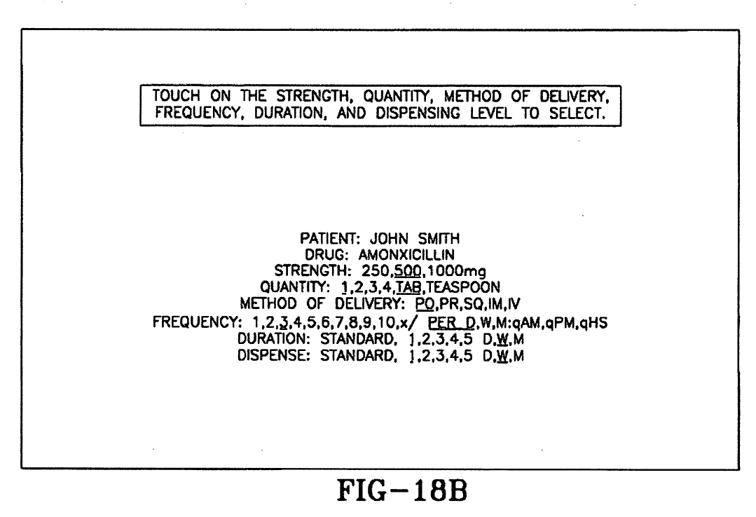

FIG. 18A is a block diagram of the process of automatically writing a prescription for a patient. An advertisement for a medication (usually a prescription drug) that is appropriate for the patient's disease, or complaint, or condition is displayed as discussed above in FIGS. 17A and 17B. This can occur at any point in the healthcare worker's workflow. The healthcare worker, usually a physician, can select the advertisement at any time during the physician-patient encounter (including during telephone calls, or when the patient is not in the physician's presence. Selection can be accomplished in any number of ways, including but not limited to a point and click device or a light pen. Patient data and other information 351 available from the patient medical record (which may have been entered into the medical record by the patient, the physician, other medical staff, or other non-medical staff) such as the patient's age, weight, sex, race, creatinine level, disease states (such as kidney or liver disease or the like), physiological states such as diabetes, hypertension or the like, current medications, past medications, allergies, and other patient medical information 351 is merged and integrated with the advertised prescription selected by the physician to generate the prescription and treatment regimen 352. The system then is able to select an appropriate treatment regimen including strength, quantity, method of delivery, frequency, and duration of treatment in light of the patient's physiologic/medical state 352. For example, if a physician selects amoxicillin for a healthy adult the system may suggest a standard adult regimen that might include 500 mg tablets three times a day for 7 days. On the other hand, a patient with an elevated creatinine level might receive a modified regimen that could include 250 mg tablets three times a day for 7 days. An appropriate treatment regimen for a child would be based on the child's weight, and could include 1 teaspoon of 125 mg/ml amoxicillin three times a day. The patient-selected pharmacy information 353 is used to transmit the prescription to the appropriate pharmacy 354. The pharmacy may be a traditional “brick and mortar” pharmacy or may be an Internet based pharmacy. The transmission can be via the global communications network or if the prescription is to be transmitted to a traditional brick and mortar pharmacy, transmission can occur via phone or fax. The prescription can also be printed. The physician can also select the advertisement to request more information about the pharmaceutical prior to making a prescribing decision.

FIG. 18B is an illustration of a screen for prescription parameters selection screen for implementing the process of FIG. 18. In one embodiment, an electronic “prescription pad” display is designed in such manner so that the physician would not need to use drop-down menus, keyboard entry or handwritten information. All prescribing information for a specific patient on a specific medication can be included in the open display. The suggested drug regimen could be demarcated from other prescribing options by a variety of methods including highlighting text, underlining, spacing or other methods. The physician could change the suggested regimen by selecting alternative options. For example a physician may which to increase the frequency of medication to 4 tablets per day instead of three tablets per day.

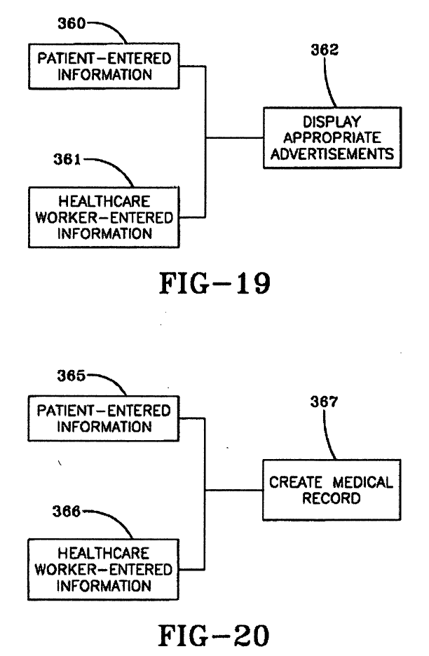

FIG. 19 is block diagram of the process of using patient-entered information and healthcare worker entered information to influence advertisement selection and display. Patient-entered information 360 can consist of any information entered by the patient, medical or non-medical. Examples include: street address, e-mail address, zip code, medical complaints, medical conditions, current medications, allergies, history of present illnesses, past medical history, family medical, and social history, and review of systems. Healthcare worker-entered information 361 can consist of any information entered by the healthcare worker about the healthcare worker or the patient and can include medical and non-medical information. The information is merged together and the appropriate advertisement is displayed for the particular situation and user 362.

FIG. 20 is block diagram of the process of using patient-entered information and healthcare worker-entered information to create a patient's medical record. Patient-entered information 365 can consist of any information entered by the patient, medical or non-medical. Examples include: street address, e-mail address, zip code, medical complaints, medical conditions, current medications, allergies, history of present illnesses, past medical history, family medical, and social history, and review of systems. Healthcare worker-entered information 366 can consist of any information entered by the healthcare worker related to the patient's medical record and can include medical and non-medical information. Examples of medical information about the patient include but are not limited to history of present illness, review of systems, allergies and current medications, physical examination findings, tests performed, lab results, interpretations, review of test and lab results, and prescribing preferences. The information is merged together and a unified medical record is created for storing in a medical record database or off-line, printing, or transmitting 367.

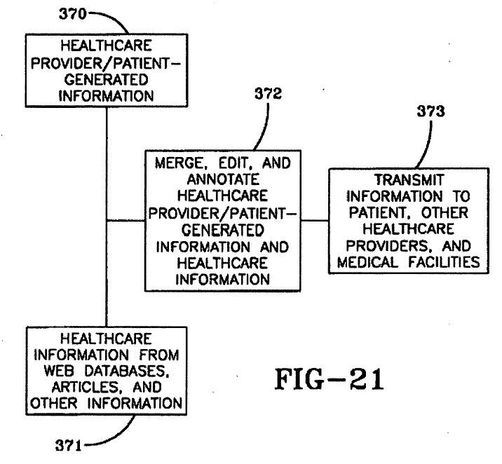

FIG. 21 is a block diagram of the process of merging healthcare provider or patient generated information and other healthcare information and allowing the healthcare provider to edit and annotate the information. Healthcare provider and/or patient generated system information 370 from the healthcare information manager and healthcare information including information from web databases, computer stored articles, video, books, audio, journals, illustrations and advertisements, computer simulations and any type of information from an Internet website 371 are merged together 372. The healthcare provider is able to annotate and where appropriate edit the healthcare information and the healthcare provider and patient generated system information. The edits and annotations can be visual (such as text or pointers on the graphical user interface), video or audio. The information, edits and annotations can be margin notes, highlighting, a commentary, a notes, a list of recommended articles, video with audio and/or written annotation, audio, computer simulations, and review notes. The merged information may then be transmitted to the patient, to another healthcare provider or to a medical facility. As an example, a healthcare provider who is a cardiologist could modify the film of a cardiogram adding voice information and visual cues such as pointers to explain to a patient the extent of the patient's coronary artery disease. The information could then be transmitted to the patient. As another example, a computer simulation of the heart could be modified by adding voice information and visual cues such as pointers to explain to a patient the extent of the patient's coronary artery disease. As another example, the annotation could be as simple as underlining a part of a journal article that the healthcare worker wants the recipient to read.

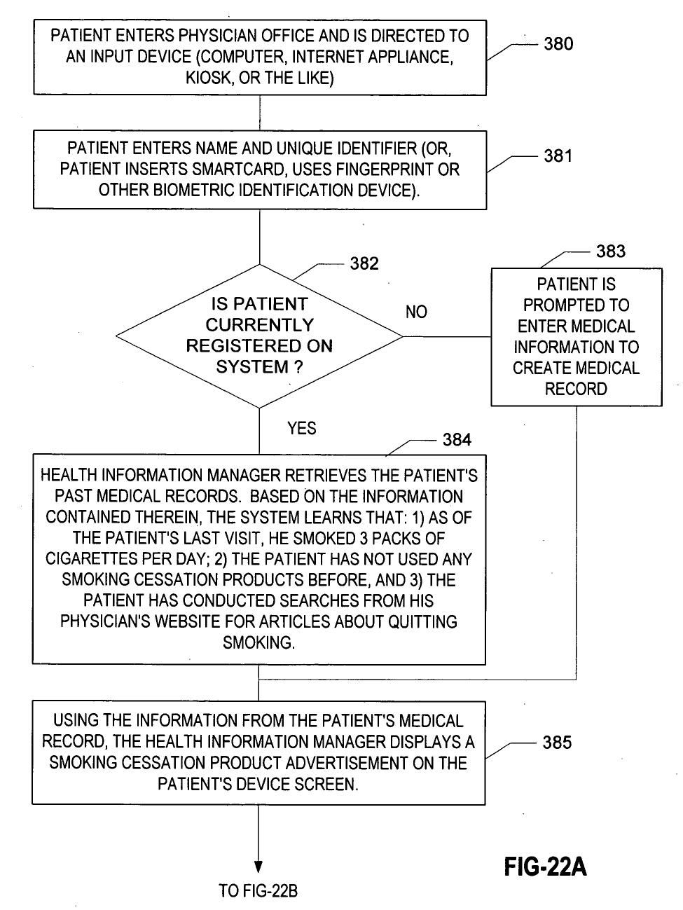

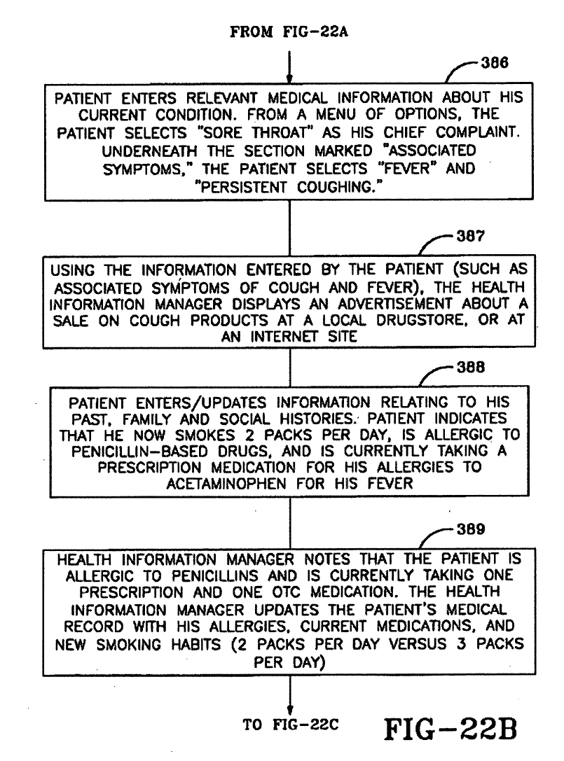

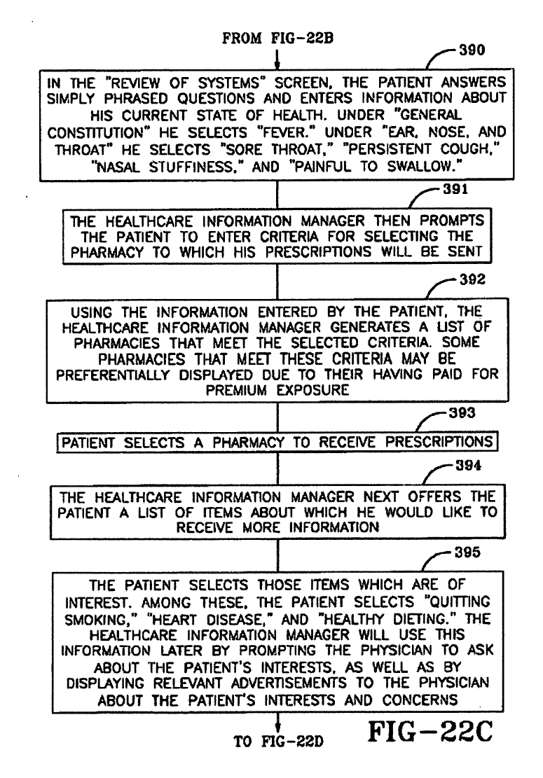

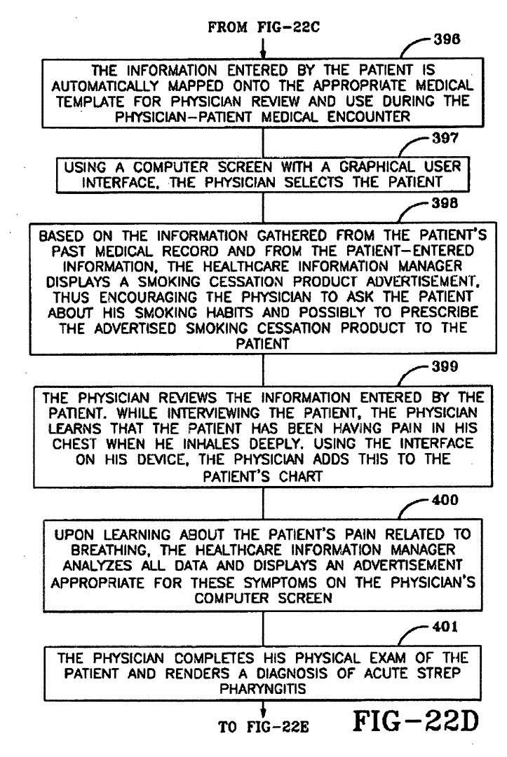

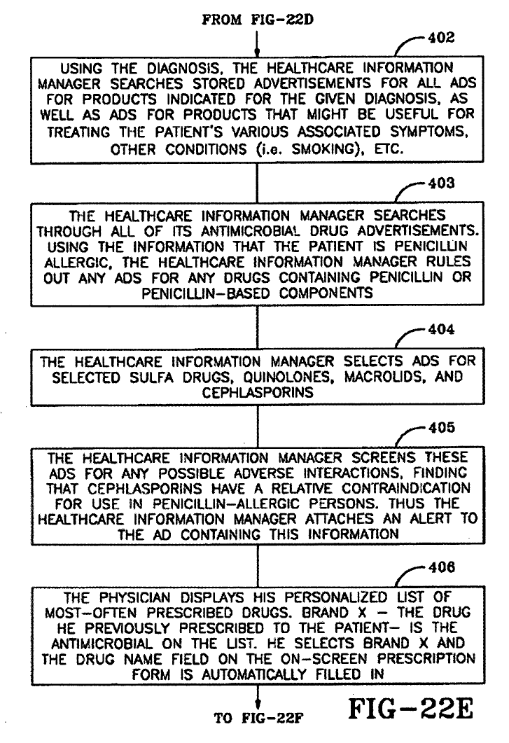

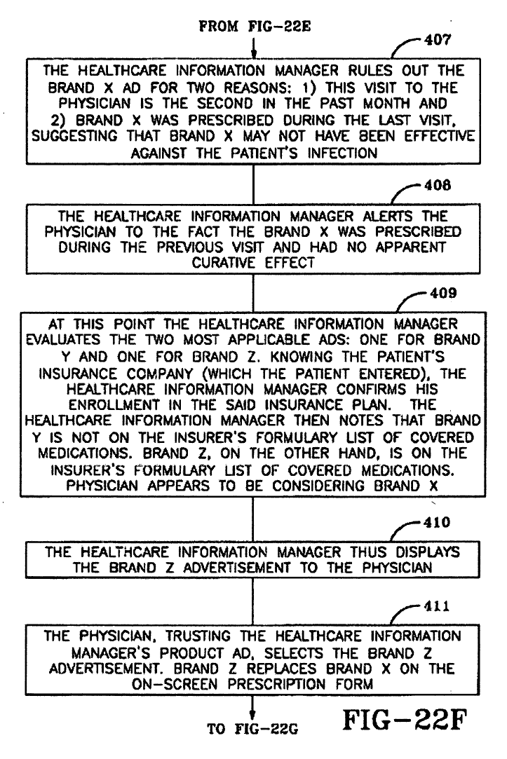

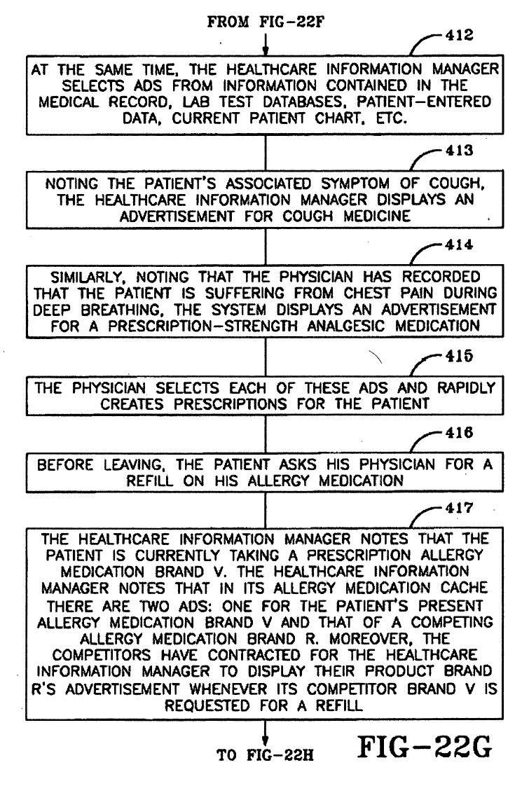

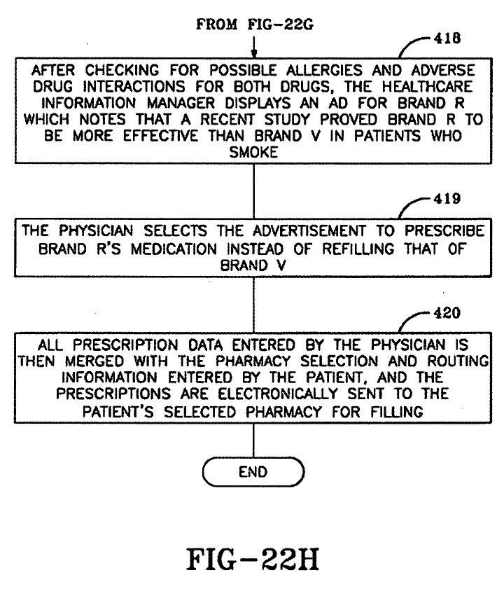

FIGS. 22A through 22H are flowcharts of an exemplary interaction of a patient and a healthcare worker with the healthcare information and delivery system. A patient enters a physician office and is directed to a computer input device 380. The patient identifies himself to the system 381. Identification can take the form of the patient entering name and a unique identifier (such as a social security number) using the computer input keyboard or mouse, inserting a smart card containing the patient's identifying information into a smart card reader device connected to the computer, or using finger print or other type of biometrics identification. If fingerprints or other type of biometrics identification is used, a biometrics device such as a reader or scanning device along with software that converts the scanned information into digital form is used along with a database that stores the biometrics data for comparison with entered biometrics data. Any type of identification scheme that identifies the patient to the health information manager computer program can be used. Once the patient is identified, if the patient is not currently registered on the health information management and delivery system 382, the patient is prompted to enter medical information that will be used to create the patient's medical record 383. If the patient is registered 382, the health information manger retrieves the patient's past medical records. For the purposes of this example, the patient is a forty-five year old male. The patient's record indicates that the patient smokes three packs of cigarettes per day, the patient has not used any smoking cessation products and that the patient has conducted searches from the physician's website for articles about quitting smoking 384. Using the information from the patient's medical record, the health information manager causes a display advertisement for smoking cessation products to be displayed to the patient computer screen 385. The patient enters relevant medical information about his current condition. From a menu of options, the patient selects “Sore Throat” as his chief complaint 386. The patient also indicates that he has associated symptoms including a fever and a persistent cough 386. Examples of relevant medical information includes chief complaint, source of referral, description of problem/complaint, location, quality, quantity, timing, settings, aggravating factors and associated symptoms. Using the information entered by the patient, such as the associated symptoms of cough and fever, the health information manager displays an advertisement about a sale on cough products at a local drugstore or at an Internet website store 387.

The patient enters/updates information relating to past medical, family medical and social histories 388. In this example, the patient indicates that he now smokes two packs of cigarettes per day, is allergic to penicillin-based drugs and is currently taking a prescription medication for allergies and acetaminophen for his fever. Examples of such information include but are not limited to general health, childhood illnesses, adult illness, psychological conditions, injuries, operations, hospitalizations, family medical conditions, smoking/drinking/drug habits, allergies, current medications and work environment hazards.

The health information manager uses this information, in this case particularly the allergy and current medications to screen advertisements to display to the healthcare worker or to the patient 389. The health information manager updates the patient's medical record with this new information. The patient proceeds to the “Review of Systems” screen 390. The healthcare information manager may prompt the patient to go to this screen or may automatically display the Review of Systems screen to the patient based upon where the patient is in the process. A review of systems includes but is not limited to the patient's general constitution, neurological system, ear, nose and throat, respiratory system, cardiovascular system, genito-urinary system, gastrointestinal system, endocrine system, integumentary (skin) system, musculo-skeletal system. The patient answers questions and enters information about his current state of health. In this example, the patient selects “fever” under the category General Constitution. Under the category Ear, Nose and Throat he selects “sore throat” “persistent cough”, “nasal stuffiness”, and “painful to swallow”.

The healthcare information manager then prompts the patient to enter criteria for selecting the pharmacy to which prescriptions will be sent 391. Examples of such criteria include but are not limited to: pharmacy location (by city, street, zip code, etc.), hours of operation, insurance acceptance, delivery options available and type of store (grocery, pharmacy, Internet web site). Using the information entered by the patient, the healthcare information manager generates a list of pharmacies that meet these criteria. Some pharmacies may be preferentially displayed due to having paid for this premium exposure 392. The patient selects a pharmacy to receive prescriptions 393.

The healthcare information manager next offers the patient a list of items about which the patient may wish to receive more information 394. The patient selects those items that are of interest 395. Examples of such items include but are not limited to: quitting smoking, heart disease, healthy living, congestive heart failure, stroke, high blood pressure, arthritis, genetics and disease, and lowering cholesterol. In this example, the patient selects “quitting smoking”, “heart disease”, and “healthy dieting”. The healthcare information manager will use this information later by prompting the physician (or healthcare worker) to ask about the patient's interests, as well as by displaying relevant advertisements to the physician about the patient's interests and concerns.

The healthcare information manager maps the information entered by the patient onto the appropriate medical template for physician review and use during the physician-patient medical encounter 396.

Using a computer screen with a graphical user interface, the physician selects the current patient 397. Based on the information gathered from the patient, any past medical history stored for the patient, and physician information that has been previously entered into the system, the healthcare information manager then displays advertisements pertinent to the patient and the physician. In this example, the healthcare information manager displays a smoking cessation product advertisement, which may result in the physician asking the patient about his smoking habits and possibly result in the physician prescribing a smoking cessation product.

Next, the physician reviews the information entered by the patient 399. While interviewing the patient, the physician learns that the patient has been having pain in his chest when he inhales deeply 399. Upon learning about the patient's pain related to breathing, the healthcare information manager analyzes all data and displays an advertisement appropriate for this symptom on the physician's computer screen 400.

The physician completes his physical exam of the patient and renders a diagnosis of acute strep pharyngitis 401. Using the diagnosis, the health information manager searches stored advertisements for all advertisements for products that might be useful for treating the patient's various associated symptoms and other conditions (in this example, smoking) 402. In this example, the healthcare information manager searches through all of its antimicrobial drug advertisements. Using the information that the patient is penicillin allergic, the health information manager rules out any advertisements for drugs containing penicillin or penicillin-based components 403.

The health information manager selects drug advertisements for selected sulfa drugs, quinolones, macrolids and cephlasporins 404. The health information manager screens these advertisements for any possible adverse interactions 405. It is found that cephlasporins have a relative contraindication for use in penicillin allergic persons. The health information manager attaches an alert to the advertisement containing this information 405.

The physician displays his personalized list of most often prescribed drugs 406. One drug previously prescribed for this patient is Brand X. The physician selects Brand X and the drug name form is automatically inserted onto an onscreen prescription form. The health information manager 407 deselects the Brand X advertisement for two reasons: this visit to the physician is the second in the past month and Brand X was prescribed during the last visit, suggesting that Brand X may not have been effective against the patient's infection 407. The health information manager alerts the physician to the fact that Brand X was previously prescribed and had no apparent curative effect 408.

The health information manager evaluates the two most applicable advertisements based on the patient and physician entered information 409, including the patient's insurance coverage and the insurer's formulary list of covered medications. In this example, the health information manager selects a different drug, Brand Y, which is covered by the patient's insurance company 409. An advertisement for Brand Y is displayed to the physician 410.

If the physician selects the drug advertisement, the selected drug is inserted onto the on-screen prescription form 411. At the same time, the health information manager selects advertisements from any information contained within the system including the patient's medical record, lab test databases and patient-entered data 412. Noting the patient's associated symptom of cough, the health information manager displays an advertisement for a cough medicine 413. It may also display an advertisement for a prescription strength analgesic for treating the patient's chest pain 414. Since all advertisements are patient specific for either the chief complaint, diagnosis, associated symptoms or other patient conditions, the physician may prescribe any of these medications by selecting the advertisement.

In this example, the physician selects each of these advertisements and a prescription is generated for each 415. In this example, the patient then asks the physician for a refill for allergy medication 416. The health information manager checks the medical record and finds the name of the current allergy medication, Brand V 417. In this example, two advertisements for allergy medications have been previously stored in the system one for the patient's medication and that of a competitor allergy medication 417. The competitor allergy medication Brand R is displayed as an advertisement because the competitor's company has paid for that service whenever Brand V is requested for a refill. After checking for possible allergies and adverse reactions for both drugs, the health information manager displays an advertisement for the competitor's allergy medication Brand R 418. The physician selects the advertisement and the medication is prescribed 419. All prescription data entered by the physician is then merged with the pharmacy selection and routing information entered by the patient and the prescriptions are electronically sent to the patient's selected pharmacy for filling. If the prescription includes drug refills, the healthcare information management system has the capability to send less than the total number of refills of the prescription to the pharmacy and to store the refills. The patient can then have the prescription refilled at a pharmacy that is different from the pharmacy that filled the original prescription.

Practitioners versed in the state of the art will recognize that other variations are possible. For example, the organization of menus or organization of the selection process might easily be changed without changing the fundamental nature of the process.

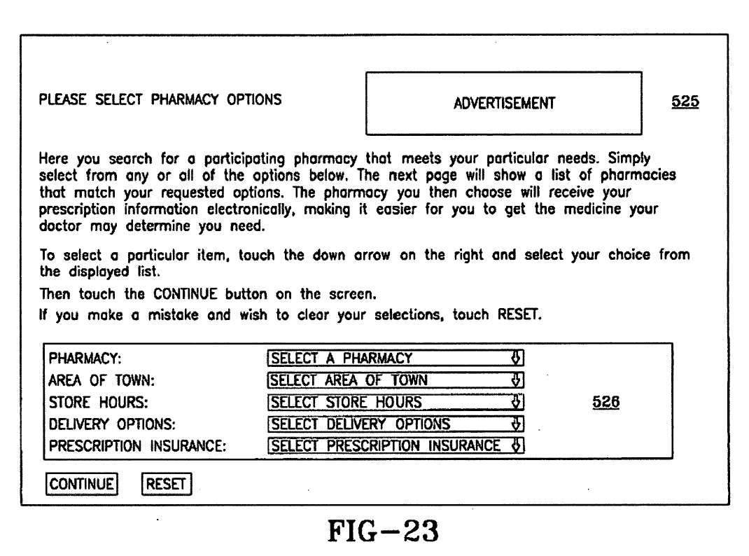

FIG. 23 is a pictorial screen diagram illustrative of a pharmacy selection screen. This screen 525 may be used by a patient to enter selection criteria 526. The health information manager performs an analysis of the selection criteria 526 to determine specific pharmacies that meet or most nearly meet the patient's criteria. FIG. 24 is a pictorial screen diagram illustrative of a selected pharmacy display screen 527. The specific pharmacies 528 are listed on a pharmacy display screen shown: FIG. 25 is a pictorial screen diagram illustrative of a pharmacy map screen 529. The specific pharmacy selected by the patient in FIG. 24 is shown on the map 530.

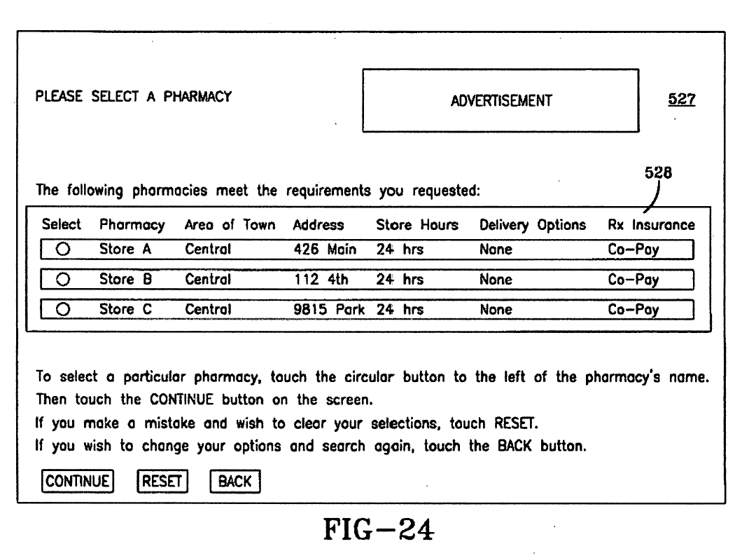

FIG. 26 is a pictorial screen diagram illustrative of a screen displayed to a patient when the patient logs onto the health information management system, using their patient identification number 531. In this example, a patient actuates a hyper-link to the patient's cardiologist. This screen is customized not only to the patient but also the patient's cardiologist, and the general field of cardiology. Links throughout the patient-cardiologist customized screen 531 create connections to various cardiology topics including current cardiology news, medical and other opinions, books and periodicals, treatment updates, and conference summaries. Other links allow the patient to receive advertising relating to various products including medical products and services 532. The patient-cardiologist customized screen 531 also includes links to a screen that allows the patient to make an appointment with the patient's cardiologist, and links for execution of on-line medical testing such as blood pressure testing.

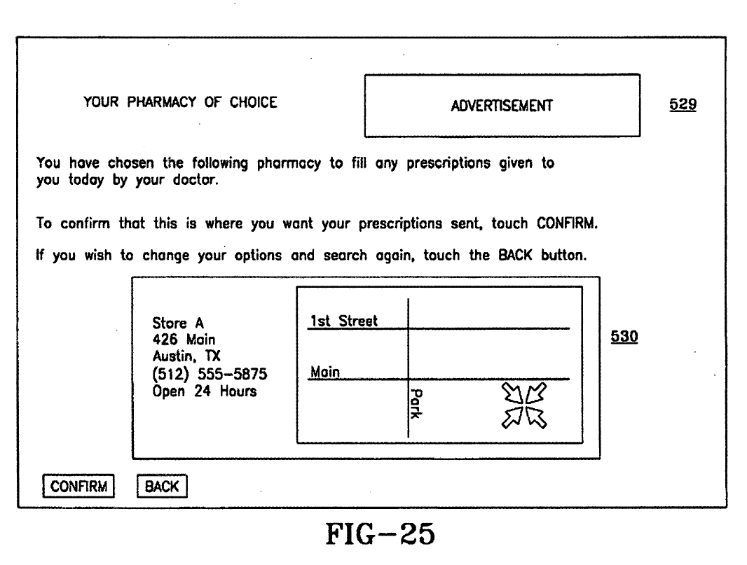

In the example, the patient actuates the “update blood pressure” link to display a blood pressure entry screen 533 shown in FIG. 27. FIG. 27 is a pictorial screen diagram illustrative of a customized blood pressure data input screen.

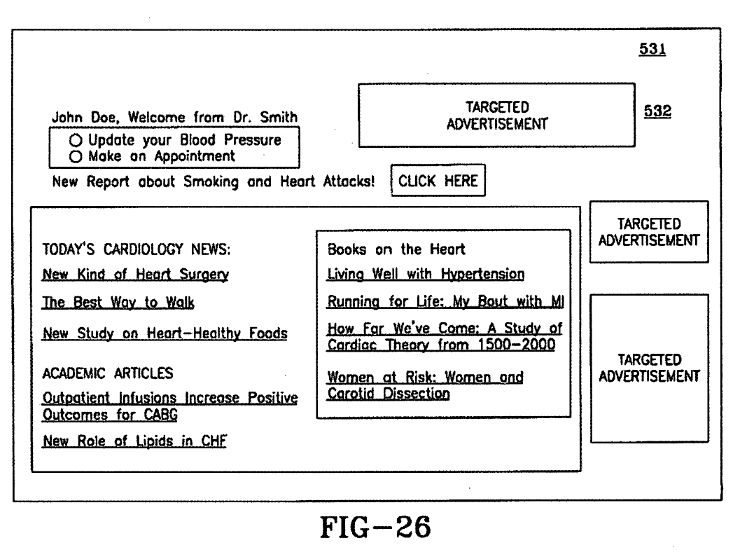

In some embodiments, the patient takes a blood pressure measurement using conventional products (cuffs) and procedures and enters the measurement result via keyboard onto the blood pressure entry screen 533. In other systems, the patient's computer may have a signal acquisition interface electronically measures the patient's blood pressure. Other types of medical and physiological testing may be performed using other medical products and devices. The patient enters the blood pressure reading 534 and selects “Graph This Entry” 535. The blood pressure reading 534 and selection 535 are transmitted to the health information manager, which logs the data and transmits the graph results back to the patient as shown in FIG. 28.

FIG. 28 is a pictorial screen diagram illustrative of a customized blood pressure results graph screen. After the patient enters or acquires a blood pressure measurement, the health information manager may generate a time graph of blood pressure measurements 537 as shown in a blood pressure graph screen 536.

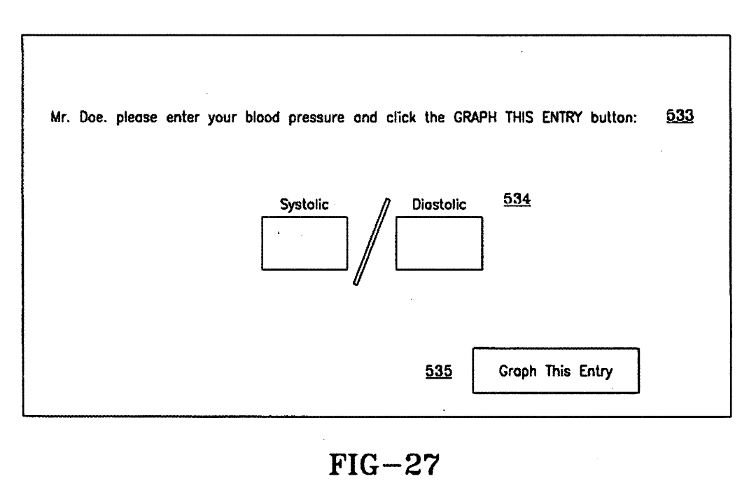

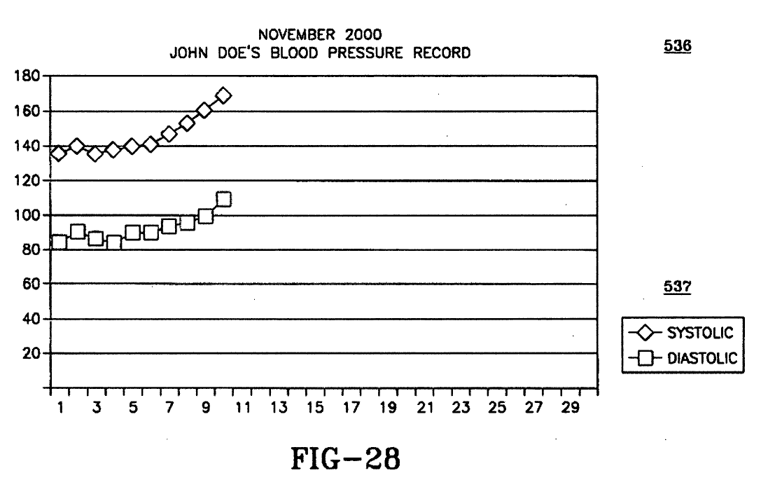

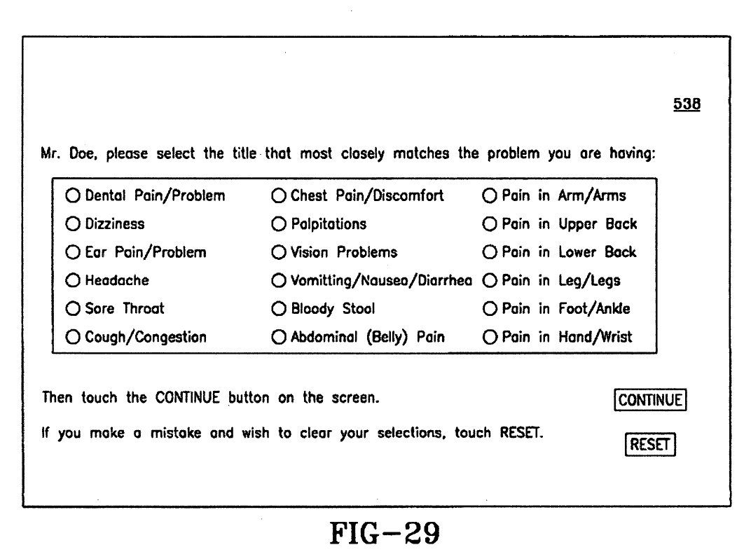

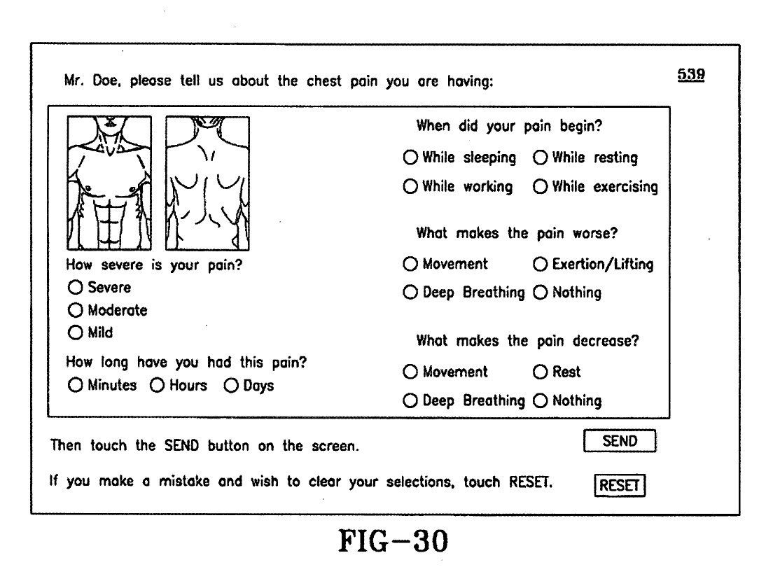

FIG. 29 is a pictorial screen diagram illustrative of a customized patient complaint screen 538 requesting the patient to indicate current physical symptoms. This screen may be displayed to the patient while he or she is accessing the health information management system from outside of the healthcare facility or when the patient is at the healthcare facility, such as the physician's office. For example, the patient may actuate an appointment link to request an appointment with the physician and a primary-level patient-complaint template 538 is displayed. Or the patient may enter the data while waiting to see a physician at a healthcare facility or physician's office. In the example, the primary-level patient-complaint template 538 requests the patient to enter one of a plurality of diagnostic conditions. When applicable conditions are flagged, the patient actuates a condition button to advance to a complaint-specific diagnostic template 539 shown in FIG. 30. The complaint-specific diagnostic template 539 is configured by analyzing information entered when the patient fills in data the primary-level patient-complaint template in FIG. 29. Once the physician has entered information and/or confirmed the information entered by the patient, the merged patient and physician information combines to form a current medical record 835 which would be similar to the patient record shown in FIG. 10. Typically, the merged current medical record is transmitted to a database in the healthcare information manager for storage and/or to the physician's printer or to a display on the physician's computer or personal access device (PDA).

While the patient is logged onto the system, preferably from a home computer system, the patient can conduct various transactions including: (1) receiving electronic mail such as e-mail containing information requested by the patient from the patient information and prescription handling system database, (2) confirming prescription data, (3) actuating information access icons on the display screen to request and read medical information and prescription data, and (4) actuating icons to access sales and marketing information. Sales information extends beyond pharmaceuticals and medical products to general products. The sales information is targeted to the particular patient on the basis of the patient's physical condition, diagnostic data, and other information within the patient's files in the patient information and prescription handling system database.

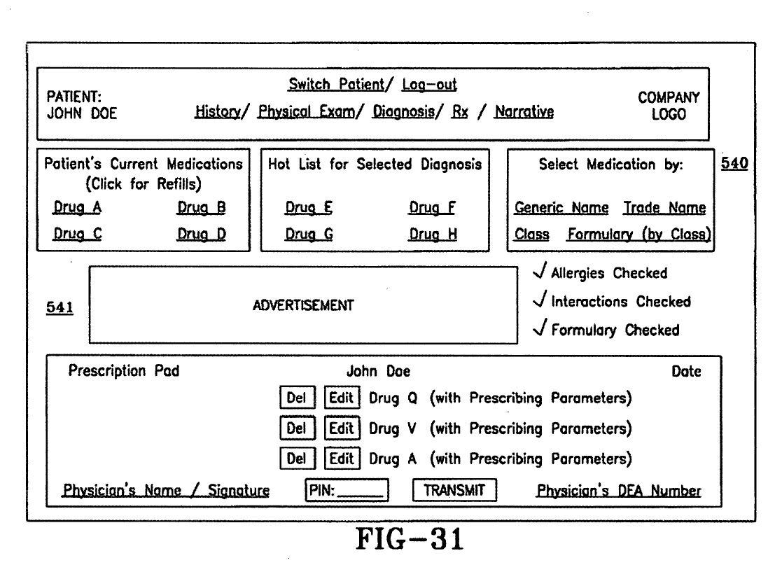

FIG. 31 is a pictorial display diagram illustrative of a customized prescription pad screen 540. The display may be viewed on a PDA type device or on any suitable device such as a personal computer, a workstation, a kiosk, or any other type of display device capable of communicating with the health information management system. An advertisement may be displayed 541 during the physician transaction. Once the physician selects a patient, advertisements are custom-selected according to a specific patient's conditions, needs, current symptoms, medical and healthcare history, interests, and other specialized information. Software in the health information manager is designed to use patient information including current symptoms, health history information, and other patient and physician entries to specifically target the physician's patient to generate the most effective advertising to the physician at the most effective time. For example, if a patient is diagnosed with diabetes, intelligent programs in the healthcare information manager may generate advertisements for diabetes medications.

In some systems, advertisements are supplied on the physician PDA device screen using a touch screen display that is specifically configured for the particular patient. When the physician touches an advertising icon, software is selectively activated in the healthcare information manager that automatically fills or refills a prescription. Thus the physician efficiently “writes” a prescription by simply selecting a particular medication on a screen from a list of the patient's current medications or a list of medications that are commonly prescribed for the patient's condition, or by simply pressing an advertisement icon displayed on the screen. The prescription pad screen 540 includes entry fields for entering a patient name, prescription, and refill options. Rather than typing in a patient name, the physician may actuate a patient name key to change the display to a patient list display of the prescription pad. The patient list display allows the physician to view a list of the physician's patients. After the physician has selected the patient, the physician may enter a prescription by any of the aforementioned means. The prescription list allows the physician to view a list of the patient's current medications or a list of common medications for the patient's condition. The prescription list display shows all current prescriptions for the particular patient and alternative prescriptions that may be substituted by the physician to reduce costs or improve selection for the patient.

When the physician selects a medication and selects a refill option by actuating a key on the display. The physician completes the prescription pad screen 540, typically near the end of the patient's office visit, to place an order for one or more medications or other products, specify the number of refills for the medications, and display newly-specified prescriptions for the patient.

FIG. 32 is a flowchart of the process of storing refills of a prescription for future use. Typically, when a physician writes a prescription for a patient which includes refills, the pharmacy that fills the initial prescription gains “rights” to fill the remaining refills, thus “cornering the market” on the refill options for that particular prescription order. In the present system and method, when a physician writes a prescription order that includes refills, those “refill options” are electronically stored in a database and only a single prescription order is sent on to the selected pharmacy for fulfillment. Therefore, when the time comes to refill the prescription, the patient, not the initial filling pharmacy, has control over those refill options. For example, the patient may elect to send the first refill order to a pharmacy near the patient's home, the second refill to a pharmacy near the patient's office, and the third refill to an Internet-based pharmacy. This allows the patient to shop for the greatest convenience and/or value for refill prescriptions, rather than being tied to the pharmacy that filled the initial order. The system also prevents a patient to refill a prescription before the stated time allotment on the previous prescription order has expired. In other words, a patient can't send refills to more than one pharmacy at a time, nor can he submit a refill order before his current order (for example, a 30-day medication supply) passes its 30-day waiting period.

In the process of FIG. 32, a prescription with refills exists within the computer system 50. The system transmits an order for a single medication supply (meaning without refills) to a pharmacy 651. The pharmacy may be a brick and mortar pharmacy or may be an Internet based pharmacy. The transmission may occur electronically using a communications network. The system stores the refills in a database for future use 652. If the patient requests refills 653, the system transmits refills to a patient-selected pharmacy 654 which may be a different pharmacy than the pharmacy that filled the original medication supply and may be different from the pharmacy that filled other refills of this prescription. If there are refills left on the prescription 655, the process repeats at step 651. Otherwise the process ends 656.

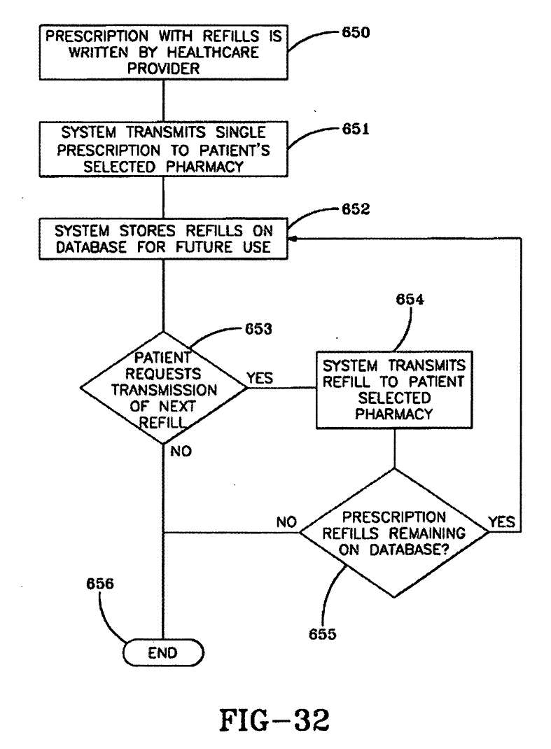

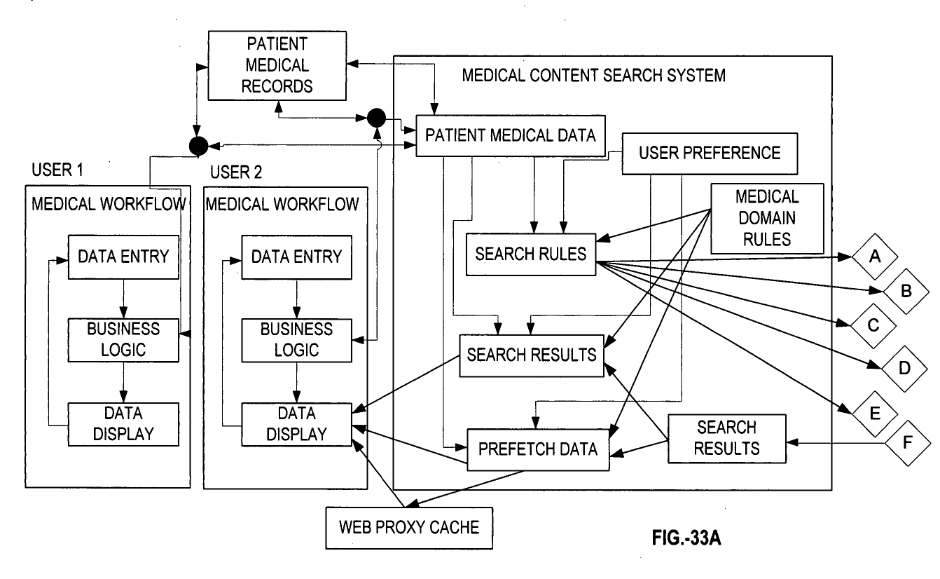

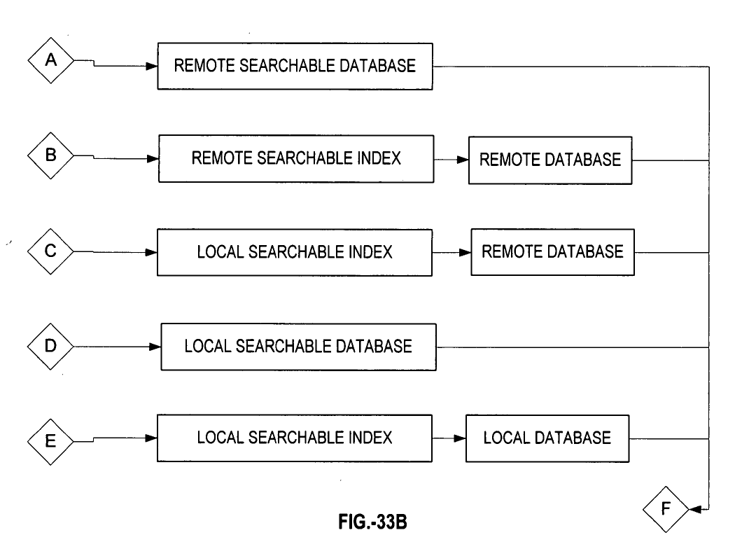

As illustrated in FIGS. 33A and 33B, a system diagram of the integrated medical search architecture, the system consists of one or more medical workflow systems in which users create, view, and edit patient medical records. Collectively, information entered by users about a patient as well as stored patient medical records comprise patient medical data. To generate content that will be integrated into a users medical workflow, the medical content search system feeds this patient medical data as well as user preferences into a set of search rules. Based on the search rules, the system issues zero or more searches to local or remote searchable databases or indices. Data returned from the searches are stored in medical content search system as search results. As the searches complete, or as a subset of the searches complete, the results from the searches are sent to the select results subsystem and the prefetch data subsystem. The select results subsystem uses the result of the search, patient medical data, and user preferences to select and prioritize search results. These selected and prioritized results are sent in full or summary form to be displayed in the users medical workflow. In addition, search results are sent to the prefetch data subsystem, which uses information from the search results, patient medical data, and user preferences as input to a set of rules that control prefetching. The selected data is prefetched and stored so that if a medical workflow references a prefetched objects, the object may be displayed rapidly. As the medical encounter progresses, users enter additional information into the system, and the system may progressively refine its search criteria to provide progressively better results to the users.

In an exemplary implementation, the system architecture consists of a set of terminals from which users access medical workflows, one or more servers for executing medical content search, and one or more servers that store medical content databases. The systems are connected by wireless and wired networks across room, building, local area, campus, and wide area networks and internetworks. For example the terminals may be wireless tablet form factor devices that connect to a search server via a local-area wireless network, and the search server may be a stationary computer that communicates with medical content databases via an Internet connection. This is shown in FIG. 3.

A wide variety of connections between the medical workflow's and medical content search system are possible. For example, searches may be triggered by data entry, data change, timers, or notification of medical content change. For example, searches may be triggered synchronously such as a system where data entered on a screen immediately results in search results be displayed on the same screen or in immediately subsequent screen or asynchronously such as a system where data entered when a patient makes an appointment results in searches that are displayed when the patient arrives at that appointment. For example, data entered by one user may trigger searches that are displayed to the same user or data entered by one user may trigger searches that are displayed to a different user. For example, the system may progressively refine search criteria and re-issue or re-evaluate searches as additional information is entered by users of the system.

The medical workflow system that provides methods for users to execute medical tasks associated with patient care. Users include entities such as patients, patient proxies, and healthcare providers. Patient proxies include entities such as legal guardians, parents of minor patients, and computerized patient agents. Healthcare providers include entities such as administrative staff, nurses, medical doctors, interns, attendants, orderlies, or other medical practitioners. Example tasks included in a patient's workflow include registration, entry of chief complaint, entry of history of present illness, entry of allergies, entry of past family, medical, and social history, entry of review of systems data, entry of pharmacy preference, selection of topics of interest/concern, entry of demographic information, entry of identifying information, and entry of business information such as insurance company. Example tasks included in a staffs workflow include patient registration, review of insurance information, review of demographic information, and review of other patient entered information. Example tasks included in the physician or ancillary medical staff workflow include patient selection, review/edit Chief complaint, review/edit history of present illness, review/edit review of systems, review/edit physical examination, review/edit active problems, review/edit past family medical and social history, review/edit current medications, review/edit assessment, review/edit diagnosis, review/edit coding, review/edit laboratory orders, review/edit radiology orders, review/edit Rx orders, review/edit release orders, review summary, and review narrative.

In an exemplary implementation, the medical workflow is implemented as a data entry subsystem, a business logic subsystem, and a data display subsystem. In such implementation users repeatedly enter data, this data and stored medical records are processed by business logic, and the results are displayed to the user, stored to patient medical records, and sent to the medical content search system.

The medical content search system uses patient medical data, user preferences, and medical domain specific rules to issue a set of searches to one or more medical content databases, receive the results, select and prioritize the results and send them the user display, and prefetch data related to search outputs that the user is likely to reference the future.

An exemplary implementation of the medical content search system consists of patient medical data, user preferences, medical domain rules, search subsystem, select results subsystem, prefetch data subsystem, and search results.

Patient medical data includes medical information about a specific patient. User preferences include information about a users preferences/priorities foreseeing certain types of data. Examples of such information include information about a user's medical specialty, explicit choices by users to include/exclude specific types of information, explicit choices by users to increase/decrease the priority of certain types of information, information about user interests/priorities inferred from previous user interactions with the system, and information about user interests/priorities retrieved from other databases.

Medical domain rules include rules for how to take patient medical data, user preferences, and search results to initiate specific searches to specific medical content databases, organize search results for integration with a specific instance of a workflow medical workflow, or prefetch data likely to be of use for a particular medical workflow.

Searches can be automatically initiated by the system under a variety of conditions based on the user preferences and the specific rules. For example, the system allows for medical staff or physician entered information to trigger the initiation of a search. An example would be initiating a search after a physician has entered an actual diagnosis for a patient.

Tables 1 and 2 illustrate an example set of inputs to the medical domain rules.

Table 3 illustrates examples search rules based on the example input data formats provided in Tables 1 and 2. The search subsystem uses patient medical data, user preferences, and medical domain rules to initiate searches to a collection of medical content databases.

For example, given the data illustrated in Tables 1 and 2 and the rules illustrated in Table 3, the search system would initiate the following searches. Based on rule one, the search system would issue a request to database 1 with the argument “cough”; this particular search might be appropriate for a remote database that the system recognizes to be a general medical information database. Based on rule 2 and medical domain specific information, the search system would first determine that the chief complaint (cough) is a complaint that is related to the cardiovascular system; because in this example it is, the search system would issue a request to database to with the parameters “complaint cough, duration=four days, severity=severe, body mass index=0.56, tobacco user=no”; this particular search might be appropriate for a remote database that the system recognizes to be a database with detailed information about I cardiovascular disease. Based on rule 3, the search system would issue a search with the arguments “cough”; this particular search might be appropriate for remote database that the system recognizes to be a database that contains high priority medical bulletins. Based on rule No. 4, the search system would issue a search with the arguments “gender=mail, age=50 years, complaint=cough, smoking=no”; this particular search might be appropriate for remote database that the system recognizes to be a database that contains lists of available clinical trials that are looking for participants. Based on rule 5 the system would issue a search of database 5 with the parameter “78746”; this particular search might be appropriate for a remote database that the system recognizes to be database the contains environmental information such as air quality, pollen count, or pollution information. Based on rule 6, the search subsystem would issue a search with the arguments “cough” to database 6; this particular search would be appropriate for a general medical database that returns results of various categories and were the search results explicitly indicate the categories of different elements of the results.

Such searches may be initiated at a particular designated point in the workflow or progressive refinement searches may be issued as additional medical information becomes available to the system.

The select results subsystem uses patient medical data, user preferences, medical domain rules, and search results to select, prioritize, and organize the results of a set of searches.

For example, given the data illustrated in Tables 1 and 2 and the rules illustrated in Table 3, the select results subsystem would organize the search results as follows: articles listed in the results of search one would be given priority 6 if they indicate a publication date during the last month or priority five if they were published earlier them at; articles listed in the result of search two would be given priority 8; articles listed in the results of search three would be given priority 7; articles listed in the results of search four would be given priority 7; articles listed in the results of search fly would be given priority 10 (Max priority) because the domain specific medical information system would recognize that the patient's chief complaint and additional complaint are breathing related. The select results subsystem would then sort the results based on priority and pass the results back to the patient care workflow.

Other organizations of the select results subsystem are possible. For example, the system might provide a general template that bitmaps the result of specific searches to specific positions in the combined results; the system might provide complaint—specific templates that organize results differently depending on the patient's chief or additional complaints; or the system might sort results based on category of results instead of or in addition to priority.

Search selection for display may occur price during the workflow or search selection may be invoked repeatedly to refine the selection as more medical information is entered into the system.

The prefetch data subsystem uses patient medical data, user preferences, medical domain rules, and search results to select items referenced by the search results to prefetch data that it predicts is likely to be used by the user.

For example, given the data illustrated in Tables 1 and 2 and the rules illustrated in Table 3, and the resulting search data, the prefetch system would first fetch results marked as bulletins or announced medications—e.g., the results of search No. 3—because they are expected to be frequently fetched by the user. If additional network bandwidth or local storage space are available, the system might also prefetch data from other categories of results.

Implementations in which the prefetch data subsystem initiates a prefetch at a particular point in the workflow or implementations in which the prefetch data subsystem repeatedly issues prefetches as more medical information is entered by users are both possible.

The system stores the prefetched data and supplies it when the user makes matching requests. An example organization to accomplish this would be for the prefetch data subsystem to insert results into a web proxy cache through which requests for the medical workflow system flow.

This implementation integrates the results of the medical content search system into the medical workflow system via the data display subsystem. Various options for display of the search results are possible. For example, the system could include the search results in an extra “frame” in the window display. The system could include the search results in a separate window or dialog box. The system could provide a pulldown menu that includes the results of the search. The system could include an additional step in the workflow designed explicitly to review search results. For example, a patient registering to see a doctor might be shown a list of related information resources. A doctor's workflow might include a step in which a doctor can review information relevant to treating the current patient.

In a second exemplary implementation of the medical content search system, an automatic, semiautomatic, or manual procedure is used to search the collection of databases to generate a set of common composite search results each of which may apply to a collection of patients meeting certain criteria. For example, the system might pregenerate a set of results that contain the related information from the databases for a “male smoker age 40-60 complaining of respiratory distress”, a set of results for “female pregnant age 20-35 well-baby-visit.” The system then uses patient medical data, user preferences, or medical domain rules to select an appropriate pregenerated set of results to integrate into the medical workflow or to further customize/prioritize the results from the pregenerated screen.

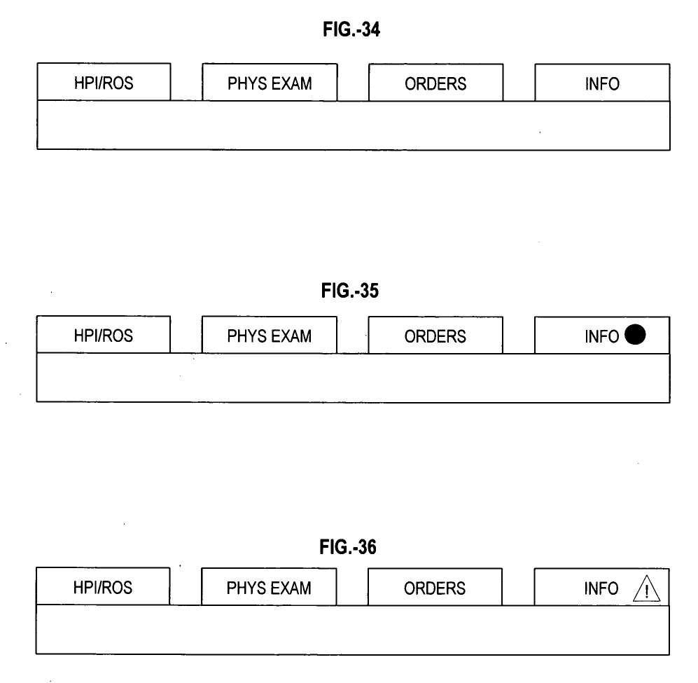

FIGS. 34, 35 and 36 are partial screen views of an integrated medical search. FIG. 34 illustrates a partial screen view of an integrated medical search before a search complaints or when no relevant data were located. FIG. 35 illustrates a partial screen view of an integrated medical search after a search completes where the data that were located are routine. FIG. 36 illustrates a partial screen view of an integrated medical search after a search completes where the data that were located are of high priority. The system uses a small icon to indicate that a relevant search has completed or to indicate the priority of the results of that search.

This system is capable of integrating with various medical content databases stored locally or remotely whether they are directly searchable or searchable via separate indices or search services that, themselves, may be local or remote. Examples of such databases include medical information portals such as Dr. Koop™ or WebMD f”, general search engines or portals such as AltaVisfa™ or Yahoo!™, medical references such as the Physician Desk Reference, company information such as the Pfizer web site, medical news sites such as the Center for Disease Control, ICD9 code databases, government regulations, insurance company regulations, insurance company benefit information, insurance formularies, billing databases, general news sites, medical journals such as the New England Journal of Medicine, environmental condition databases, clinical trial databases or advertisements, databases of drugs applying for FDA approval, medical consultants databases, medical case studies, expert systems on medical topics, expert systems on medical billing and coding, and the like. Examples of separate indices or search services include manually generated indices, automatically generated indices, indices generated by expert systems, indices generated automatically and refined manually, and the like.

In a second exemplary implementation of the medical content search system, an automatic, semiautomatic, or manual procedure is used to search the collection of databases to generate a set of common composite search results each of which may apply to a collection of patients meeting certain criteria. For example, the system might pregenerate a set of results that contain the information from the databases for a “male smoker age 40-60 complaining of respiratory distress”, a set of results for “female pregnant age 20-35 well-baby-visit.” The system then uses patient medical data, user preferences, or medical domain rules to select an appropriate pregenerated set of results to integrate into the medical workflow or to further customize/prioritize the results from the pregenerated screen.

Using the foregoing, the system may be implemented using standard programming or engineering techniques including computer programming software, firmware, hardware or any combination or subset thereof. Any such resulting program, having a computer readable program code means, may be embodied or provided within one or more computer readable or usable media, thereby making a computer program product, i.e. an article of manufacture. The computer readable media may be, for instance a fixed (hard) drive, disk, diskette, optical disk, magnetic tape, semiconductor memory such as read-only memory (ROM), or any transmitting/receiving medium such as the Internet or other communication network or link. The article of manufacture containing the computer programming code may be made and/or used by executing the code directly from one medium, by copying the code from one medium to another medium, or by transmitting the code over a network.

The system may include one or more processing systems including, but not limited to, a central processing unit (CPU), memory, storage devices, communication links, communication devices, server, I/O devices, or any sub-components or individual parts of one or more processing systems, including software, firmware, hardware or any combination or subset thereof, which are embodied as set forth in the claims.

User input may be received from the keyboard, mouse, pen, voice, touch screen, or any other, means by which a human can input data to a computer, including through other programs such as application programs.

The above disclosed subject matter is to be considered illustrative, and not restrictive, and the appended claims are intended to cover all such modifications, enhancements, and other embodiments which fall within the scope of the present invention. Thus, to the maximum extent allowed by law, the scope of the present invention is to be determined by the broadest permissible interpretation of the following claims and their equivalents, and shall not be restricted or limited by the foregoing detailed description.

TABLE 1
Patient medical data:

| chief_complaint = | cough |
|---|---|
| chief.severity = | sever |
| chief.progress = | worsening |
| chief.duration = | 4 days |
| additional complaint = | difficulty breathing |
| family has history of heart disease | |
| height = | 180 cm |
| weight = | 100 kg |
| smoke = | no |
| dob = | Jan. 4, 1950 |
| sex = | male |
| zip code = | 78746 |

TABLE 2
User preference data priority prefetch

| | |
|---|---|
| bulletins: 7; | frequently fetched |
| environment: 3; | seldom fetched |
| counseling: 4; | seldom fetched |
| available trials: 7; | seldom fetched |
| recent publications: 6; | seldom fetched |
| available medications: 3; | seldom fetched |
| announced medications: 8; | frequently fetched |
| general information: 5; | seldom fetched |

TABLE 3
Rule 1: SEARCH database1 USING patientRecord.chief_complaint

if RESULTS.date is during last month

SELECT RESULT using userPreference.recent_publication.priority

else

SELECT RESULT using userPreference.general_information.priority

PREFETCH RESULT using userPreference.general_information.prefetch

Rule 2: if (patientRecord.chief_complaint is related to cardio vascular system)

SEARCH database2 USING complain = patientRecord.chief_complaint, duration =

patientRecord.chief.duration,

severity = patientRecord.chief_complaint.severity, body mass index = weight/height
tabacco user = patientRecord.smoke
SELECT RESULT using userPreference.general_information.priority + 3
PREFETCH RESULT using userPreference.general_information.prefetch

Rule 3: SEARCH database 3 USING patientRecord.chief_complaint

SELECT RESULT using userPreference.bulletins.priority
PREFETCH RESULT using userPreference.bulletins.prefetch

Rule 4: SEARCH database4 USING gender = patientRecord.sex, age = today -
patientRecord.dob

complaint = patientRecord.chief_complaint, smoking = patientRecord.smoking
SELECT RESULT using userPreference.available_trials.priority
PREFETCH RESULT using userPreference.available_trials.prefetch

Rule 5: SEARCH databse5 USING patientRecord.zipCode

if(patientRecord.chief_complaint or patient_record.additional_complaint is breathing

related)

SELECT RESULT using max_priority

else

SELECT RESULT using userPreference.environment.priority

PREFETCH RESULT using userPreference.environment.prefetch

Rule 6: SEARCH database6 USING patientRecord.chief_complaint

SELECT RESULT using RESULT.[category].priority
PREFETCH RESULT using RESULT.[category].priority

The disclosure describes a computer implemented system for gathering patient medical information from a variety of sources, selecting relevant medical information of a variety of types and from a variety of sources, and integrating the delivery of that information into the patient-medical-information-gathering and patient-treatment workflow.

The disclosure describes a system that gathers information about the patient (from patient inputs, staff inputs, doctor inputs, patient records, etc.). It uses that gathered information to select information relevant to the treatment of the patient (textbook articles, recent bulletins, journal articles, clinical trials that the patient may be eligible for, recently completed clinical trials that have results relevant to the patient, CDC bulletins, adverse reactions information (perhaps before formal FDA warnings are issued), local pollen counts, local pollution readings, information about the manufacturing company of a potential drug, information about potential drugs in the pipeline for a given condition, outcome information for a given condition, etc.) from a collection databases (synchronously or asynchronously). The disclosure describes a system that integrates this information into the user's workflow. The user may be any authorized user of the system and would typically be a physician, nurse or the like. Examples of integrating the information into the workflow includes but is not limited to: showing a list of relevant data on a “reference” screen, adding a list of relevant data to “orders” screen, putting an “icon” onto the main workflow navigation bar indicating that data are available. The user could also be a patient. If the user is the patient, as the patient is entering information, he or she can be shown a variety of data, for example, a list of articles they may want to read.

As an example, a patient enters data into the system indicating that he is a 54-year nonsmoking old male suffering from a severe cough. The system searches a medical reference database for basic reference material about coughs. It searches the Center for Disease Control database for recent bulletins about coughs. It searches an air quality database for pollution and pollen levels for the last week in the area near the patient's location. It searches several drug testing companies' databases for clinical trials available to 54-year-old nonsmoking males with coughs. When the doctor uses his electronic chart to review and enter medical information about the patient, the chart displays in a sub-window a list of relevant information that it has selected in that search, and the system prefetches the contents of those articles across the Internet to the electronic chart so that if the doctor selects an article, it can be displayed without delay. Thus, the doctor has at his fingertips articles that may help him deal with a difficult diagnosis, relevant clinical trials that he otherwise might not know about, bulletins that he might not know about, and information about a potential contributing factor (e.g., pollen) that he would generally not have time to gather.

Relevant information is of many different types (for example, ranging from current pollen readings to recent CDC bulletins to journal articles.) A doctor may want to search the CDC, the PDR, the air quality web site, and five different clinical trials web sites. The disclosed system searches several locations for information at once to avoid requiring several separate searches.

Due to network and computing constraints, searching and retrieving data may take a long time, and these delays may discourage users from undertaking such searches. The system addresses this by prefetching relevant information to the doctor based on information entered by the patient.

Embodiments disclosed herein have capabilities including:

integrating data entry into health care workflow and initiate search for/selection of information implicitly as data is gathered or as workflow proceeds;

customizing search generation based on patient medical information;

customizing filtering/prioritizing/displaying search results based on patient medical information;

customizing prefetching prioritization/selection based on patient medical information;

integrating display of information into health care provider's workflow;

integrating display of search results into patient health care encounter workflow;

gathering many different types of healthcare information from many different sources (e.g., articles, bulletins, clinical trials, textbooks, air quality and the like);

selecting healthcare information to display based on patient medical information gathered from several different sources (patient, staff, doctor, patient records) and information gathered from one user about a patient may affect what is selected for display about the same patient to another user;

selecting healthcare information to display based on stored patient medical information whering information gathered about a patient during a previous medical encounter affects what is selected for display about that patient for a subsequent encounter; and

prefetching information to improve usefulness (for example, based on patient inputs, information that the doctor may need is prefeteched so that when the doctor looks for the information there is no wait time for a search and download of information and it is available at his or her display device).

Different multiple database search embodiments of the system differ from existing “meta-search” engines (that search several databases for documents matching keywords) for several reasons. In an embodiment, searches are implicitly initiated based on medical information gathered as part of an electronic workflow. In an embodiment, new selections are triggered when new data is input. In an embodiment, results are integrated into medical workflow. In an embodiment, information entered by one user (e.g., patient) may initiate a search whose results are observed by a different user (e.g., a doctor). In an embodiment, unlike a keyword search, the system may use domain-specific medical knowledge and patient medical information to issue different searches to different databases (e.g., for a nonsmoking 54-year-old male user in New York City complaining of a cough, the system might issue a search on “cough” to the CDC database but search for “New York City pollen levels” on an air quality database, and search for “cough 54-year-old male non-smoking” to a database listing current clinical trials). In an embodiment, the system may use domain-specific medical knowledge and patient medical information to control the prioritization/display of search results. In an embodiment, the system may prefetch from search results using domain specific knowledge or patient medical information.

Different embodiments of this system differ from health “portals” containing collections of articles relating to different health topics because they use patient-specific information to screen the information displayed. For example, if a patient indicates to the system that he has a cough and that he is a non-smoker, the system can customize the “cough” information to not display smoking-related articles. It integrates gathering of information to do this screening into the health care workflow. For example, patients enter information directly into the system, and that information is used to select articles that will be relevant when the patient is treated. Doctors enter information while treating a patient and that information is used to select articles that will be relevant during treatment. The system integrates display of this information into the health care workflow. For example, a doctor looking at the electronic “chart” of a patient will also see relevant articles. It may use the health-care workflow to prefetch the contents of articles to users. For example, when a doctor walks into the examination room of a patient and selects the patient on his electronic clipboard, the system can begin to prefetch the contents of articles that are relevant to that specific patient.

Embodiments include a system comprising a medical patient care workflow and a medical information search system in which actions or data entry by a user in the medical patient care workflow automatically trigger searches by the medical information search system without requiring an explicit search initiation by the user, further comprising a system where data entered by one user initiates a search whose results are observed by another user, a system where the search process proceeds asynchronously from the patient care workflow and a system where the search process may be repeatedly invoked by the system to refine the search as more data becomes available from the workflow.

Embodiments include a system comprising a medical patient care workflow and a medical information search system that automatically uses patient medical information from the workflow as input or parameters into the search system without requiring the user to copy or re-enter the information from the workflow to the search system. In one such embodiment, the system also uses user preference information, domain-specific medical knowledge, and stored medical information about the patient. In one such embodiment, the system further comprises that data entered by one user initiates a search whose results are observed by another user and data entered by one user are used as parameters to a search observed by another user. In one such embodiment, the system allows the search process to proceed asynchronously from the patient care workflow. In one such embodiment, the system allows the search process may be repeatedly invoked by the system to refine the search as more data becomes available from the workflow.

Embodiments include a system comprising a medical patient care workflow and a medical information search system that integrates the display of the results of a search or set of searches into the patient care workflow. Such embodiments further include systems where the user of the workflow is a health care provider such as a doctor, nurse, or the like; systems where the user of the workflow is a patient or patient proxy such as a parent, guardian, or the like; systems where data entered by one user initiates a search whose results are observed by another user; and systems where the search process proceeds asynchronously from the patient care workflow.

One embodiment is a system that provides for using medical information to control and refine a “meta search” of multiple health and health-related databases.

Embodiments include a system comprising a medical information search system that generates distinct queries to a collection of heterogeneous databases where the different queries to different databases may use different search parameters or search terms. One such embodiment of the system further includes a system that integrates the results of the heterogeneous queries into a composite query result; a patient care workflow system that uses patient medical information entered in the workflow or stored by the system to supply parameters to the queries and to customize the queries to be relevant to a specific patient; a patient care workflow system that uses patient medical information, user preference information, domain specific medical information to generate the queries; and a system where the search process may be repeatedly invoked by the system to refine the search as more data becomes available from the workflow.

In one embodiment, in addition to initiating the “meta search”, the system can use its domain specific knowledge and patient knowledge to integrate and prioritize the results.

In one embodiment, the described system comprises a medical information search system that selects subsets of search results to display based on medical information. One such embodiment further comprises a medical information search system that searches multiple heterogeneous databases and a medical patient care workflow system where the medical information used to select results or prioritize results consists of information about patients gathered by the medical patient care workflow or patient information stored by the system.

Embodiments allow humans to generate a page on a particular topic or set of topics and the system uses patient specific information to select the correct stock page or to customize the stock page. In one embodiment, the system further comprises a medical information search system that automatically, semi-automatically, or manually generates a set of results relevant to a class of patients, category of patients, condition, complaint, diagnosis, or medical topic and that selects or refines a particular set of results based on information about a particular patient.

One embodiment is a system comprising a medical patient care workflow and a medical information search system that prefetches particular objects that appear in the search results that further comprises using information about the current patient and user preference information to identify particular objects to prefetch.

One embodiment provides for the ability to channel patients to appropriate medical trials. This embodiment of the system includes a medical patient care workflow and a clinical trial database in which users enter information about a patient's medical condition and in which the system identifies clinical trials for which the patient is or may be eligible to participate and that alerts the user of the system of such trials. One such embodiment further includes a system in which patients entering information into a medical workflow system are notified of clinical trials for which they may be eligible based on factors such as demographic information, current medications, current medical conditions, or medical complaints. One such embodiment further includes a system in which medical professionals entering information into a medical workflow system are notified of clinical trials for which their patients may be eligible based on factors such as demographic information, current medications, current medical conditions, or medical complaints.

A computer implemented system and method for integrating patient-specific searches into a computer-based patient healthcare delivery workflow by using information entered into healthcare delivery workflow as data for search input, by initiating search implicitly as part of workflow, and by integrating display of results into workflow is disclosed. One embodiment integrates healthcare information of several different varieties from several different sources. One embodiment prefetches the contents of relevant medical data initiated by patient care workflow. One embodiment uses domain-specific and patient specific information to control what search is issued, integrate search results to be, displayed and control prefetching.

One embodiment encompasses a computer-implemented method for directing patient-specific healthcare information and healthcare product information to physicians at specific points in a physician's work cycle, such as prescription writing or doing a physical assessment. The health care information and product information that is selected to be displayed by the system is based on patient criteria such as the patient's age, gender, past medical history, current complaint, condition, allergies, current medications or formulary restrictions. The information and advertisements may also be selected for display by the system based on physician criteria such as medical specialty, geographic area or past prescribing history.

One embodiment is a computer system for displaying targeted healthcare information to a computer user comprising an information selecting computer, a plurality of devices for enabling entry of patient medical information into the system, a database for storing the patient medical information, a healthcare information selecting computer, and a communications network for transmitting healthcare related information and patient medical information among these computers, wherein the information selecting computer selects healthcare information for display to the user that is related to patient medical information entered from at least one of the plurality of devices and wherein the patient medical information comprises information received from a healthcare group consisting of healthcare providers, patients, healthcare service organizations, pharmaceutical companies, healthcare product and service vendors, pharmacies, medical facilities, healthcare information services, medical record databases, government agencies, non-profit organizations, health research organizations and billing companies. The healthcare information selected may include information relating to the patient medical information such as journal articles, textbook articles, clinical trials for which the patient may be eligible, recently published research results or clinical trial results, Center for Disease Control bulletins, adverse medication reaction bulletins, clinical consult results, case studies, air quality measurements, water pollution databases, and the like. The plurality of devices may be wireless portable computer devices, web TV devices, personal digital assistant devices, personal computers, handheld portable computers, wireless telephone devices and wireless personal access devices and the like.

One embodiment provides a computer-implemented method in which revenue can be generated from sources other than the physician so the healthcare information and delivery management system can be provided at free or at low cost to the physician user. The present system and method provides a computer-implemented system that is designed to function in a manner consistent with the way physicians practice medicine. It allows for user mobility, contains task automation tools and has the ability to collect data that is input from various sources such as the patient, staff members, and healthcare providers. It has the ability to streamline various processes such as medical record creation, prescription writing and pharmacy selection. The system may be connected to a local or global communications network, providing a seamless connection that does not require extra steps on the part of the user to transmit and receive data.

One embodiment offers a computer-implemented method for directing patient specific health care information and health care product information to physicians at specific points in a physician's work cycle, such as prescription writing or performing a physical assessment of a patient. Healthcare information is presented to the physician while he or she is with a patient. The information is targeted to the condition and symptoms of the patient. Healthcare product information and advertisements, including pharmaceutical advertisements, are displayed by the healthcare information management system and are directly linked to the conditions, histories, and medications of the individual patients and are readily available to the physician while treating a patient. The system is able to synchronize health care and product information and advertising and direct it to groups and specific individuals via the Internet.

One embodiment includes a business model in which revenue can be generated from sources other than the health care provider so the healthcare information and delivery management system can be provided at free or at low cost to the health care provider user. Health care product advertisers can supply the system to the health care provider and/or their patients, which enables the advertisers to communicate directly with health care providers and their patients. In addition, health care providers could receive revenues from using the system, for example payments for viewing health care product information and advertisements or using advertised products and services.

One embodiment encompasses a computer-implemented method for directing patient-specific healthcare information and healthcare product information to physicians at specific points in a physician's work cycle, such as prescription writing or doing a physical assessment. The health care information and product information that is selected to be displayed by the system is based on patient criteria such as the patient's age, gender, past medical history, current complaint, condition, allergies, current medications or formulary restrictions. The information and advertisements may also be selected for display by the system based on physician criteria such as medical specialty, geographic area or past prescribing history.

One embodiment of the system allows for direct patient input of information into the system to reduce healthcare provider time spent collecting information from patients via paper-based questionnaires and verbal encounters. This information is automatically entered into computer systems to form a patient record and to document patient preferences, such as pharmacy of choice and preferred healthcare products. The system also allows direct staff input of information into the system. This information is then automatically mapped onto the appropriate form for physician review, editing, and confirmation. This information then becomes part of the medical record. The system increases operational efficiency and saves time and effort currently wasted on reprocessing data gathered on paper-based forms or from verbal interviews.

One embodiment of the system and method allows for websites to be preemptively customized for health care patients along with traditional site customization by the user. The system uses data electronically collected elsewhere (such as at the medical kiosk or other device in the physician's office) to customize a patient's Web site before he or she ever actually logs onto the site. From the moment the user logs onto the site, health care information, products, services, and advertising can be targeted to address the needs and interests of the user. Users can further customize their sites according to traditional methods.

An example of a method of using the present system and method follows. A patient arrives at a physician's office and enters the appropriate information into the medical kiosk or other device in the front office. From this information, this system learns that the patient is allergic to penicillin and penicillin derivatives. When the physician examines the patient, he diagnoses strep pharyngitis. For a non-allergic patient, penicillin might be a recommended treatment option so an advertisement for such could be displayed. However, the system takes the patient's history and conditions into account so for this penicillin-allergic patient all advertisements for penicillin-based products are excluded from display. For this patient, an advertisement for erythromycin might be displayed. Knowing the physician's prescribing habits, which have been saved by the system, the brand of drug that is most often prescribed by this physician or an advertisement for a drug that directly competes with the drug most often prescribed by this physician may be displayed. This capability allows companies to advertise pharmaceuticals marketed against established products. In another example, the system filters medication information based on the patient's insurance formulary to display only on-formulary medications.

A computer system for displaying targeted healthcare information to a computer user comprising a plurality of workflow computers into which data about specific patients is entered and viewed, a plurality of healthcare data input computers into which healthcare information not specific to a patient is entered, and a communications network connecting the workflow computers and the healthcare data input computers is disclosed. The system further comprises a search routine that selects a subset of healthcare information based on patient information. The system further comprises that the workflow computer display this subset of healthcare information.

In one embodiment, the search routine transmits patient information across the network from a workflow computer to a plurality of healthcare information storage computers and sends the selected information across the network to the workflow computer. In another embodiment, the healthcare information from the data input computers is transmitted across the network to the workflow computers and the search routine operates locally.

One embodiment is a computer system for displaying targeted healthcare information to a computer user comprising a healthcare product information selecting computer, a plurality of devices for enabling entry of healthcare related information into the system, a database for storing the healthcare related information and healthcare product information connected to the healthcare product information selecting computer and a communications network for transmitting healthcare related information from at least one of the plurality of devices to the selecting computer for storage in the database, wherein the selecting computer selects healthcare product information for display to the user based on the healthcare related information entered from at least one of the plurality of devices. In one such embodiment, the selecting computer is integrated with the healthcare entry computer. In another such embodiment, the selecting computer is integrated with the storage computer.

One embodiment is a computer system for displaying targeted healthcare advertisements to a computer user comprising an advertising selecting computer, a plurality of devices for enabling entry of healthcare related information into the system, a database for storing the healthcare related information and advertising information connected to the advertising selecting computer and a communications network for transmitting healthcare related information from the devices to the selecting computer for storage in the database, wherein the advertising selecting computer compares the healthcare related information to the advertising information and selects advertising information for display to the user that is related to the healthcare related information entered from at least one of the plurality of devices. The healthcare related information comprises information received from a healthcare group consisting of healthcare providers, patients, healthcare service organizations, pharmaceutical companies, healthcare product and service vendors, pharmacies, medical facilities, healthcare information services, medical record databases, government agencies, non-profit organizations, health research organizations and billing companies. The system also may contain a database of stored non-healthcare related information connected to the advertising selecting computer wherein the selecting computer compares the healthcare related information and the non-healthcare information to the advertising information and selects advertising information for display to the user that is related to the non-healthcare information. The plurality of devices may be wireless portable computer devices, set-top boxes, web devices, personal digital assistant devices, personal computers, handheld portable computers, wireless telephone devices and wireless personal access devices and the like.

In one embodiment, the advertising selecting computer constructs a medical record for a patient using healthcare information selected from at least one of the healthcare group and transmits the medical record via the communications network to a computer user. The advertising selecting computer transmits a pharmaceutical advertisement to at least one of the plurality of devices for display via the communications network and in response to a healthcare provider user selecting the displayed pharmaceutical advertisement, a prescription for a patient is automatically created. The advertising selecting computer collects information concerning a number of patients the healthcare provider has referred to a particular website and calculates revenue to be paid to the healthcare provider user based on the number and types of the prescriptions. The advertising selecting computer calculates a revenue amount to be paid to the healthcare provider for using the computer system. The communications network is selected from the group consisting of a global communications network, a wide area network, a communications inter-network, a local area network, a wireless telephone network, a satellite network and a cable television network.

In one embodiment, the present system comprises a health information manager computer program for accepting information from a plurality of electronic sources accessed through a global communications network and organizing the information from the plurality of sources to create patient medical records and using the information from at least one of the plurality of sources to select healthcare product advertisements for display to a user based on the patient medical records and healthcare provider records.

A method of displaying targeted healthcare product information to a computer user in the present invention comprises using a medical information database, including patient medical information, and a healthcare product information database and in response to a request from a client computer, comparing the medical related information to the health care product information database and selecting healthcare product information to be displayed to the user that is related to the medical information. The user may be anyone authorized to access the medical information, particularly a patient and a healthcare provider. Healthcare product information may include healthcare service information. The healthcare product information may be an advertisement, particularly a pharmaceutical advertisement for an individual drug. Patient medical information and healthcare provider information may be collected from at least one of a plurality of sources and healthcare product advertisements are selected for display to a computer user based on the patient medical information and healthcare provider information and the advertisements are transmitted to a computer user for display. At least one of the plurality of sources information may be user entered data and user actions collected as a user navigates through an electronic web page display. The pharmaceutical advertisement for a drug is displayed on a computer screen and the healthcare provider can select the drug displayed on the screen and an electronic prescription for the drug for a patient is initiated or automatically created by the computer system. The pharmaceutical advertisement for a drug is displayed on a computer screen and the health provider can select the drug displayed on the screen and more information about the pharmaceutical is displayed. In addition, the initiated prescription can be initialized to parameter values based on the patient medical information. The electronic prescription then may be electronically sent to a patient-selected pharmacy. If the prescription contains at least one refill, at least one prescription refill may not be sent to the patient-selected pharmacy and is electronically stored for the patient. The electronically stored prescription refill may then be sent to the patient-selected pharmacy upon request of the patient.

The patient medical information includes drugs the patient is allergic to, has had adverse reactions to, drugs in the same class as drugs the patient has had an adverse reaction to, drugs the patient's family has had adverse reactions to, and drugs for which genetic profiling has indicated that the patient may have adverse reactions to. Pharmaceutical advertisements for such drugs are filtered prior to display. Using the patient medical information, the system may also predict the drugs the patient may have an adverse reaction to (based on medical history or interactions with other drugs) and filters the pharmaceutical advertisements for those drugs. Drugs that are not included in the formulary of the patient's insurance company may be filtered from the display. Filtering may comprise not displaying the drug or displaying the drug with a warning.

The display of pharmaceutical advertisements may be prioritized according to an amount of revenue received for displaying each pharmaceutical advertisement or according to the amount of revenue received for displaying pharmaceutical advertisements for pharmaceuticals from a selected company.

The computer-implemented method comprises using healthcare information collected from a plurality of sources, selecting healthcare product information for display to a healthcare provider based upon information from at least one of the plurality of sources and the process the healthcare provider has selected from a computer display within a healthcare provider's computerized workflow process and displaying the healthcare product information to the healthcare provider on the computer display during the workflow process. The display may be transmitted to the healthcare provider in real-time. The healthcare product information may be advertisements for medical products or services, which may be pharmaceutical advertisements for specific drugs. The computerized workflow process may comprise such as creating an electronic medical record for a patient, counseling the patient, reviewing the electronic medical record, updating the electronic medical record, creating an electronic prescription, selecting medical tests to be performed on the patient, reviewing results of medical tests performed on the patient, reviewing medical reference information and electronically annotating medical reference information. The plurality of sources may include information from at least one of the sources such as a patient medical record, patient-entered information, healthcare provider entered patient information, health information, medical facility entered patient information, pharmacy information and insurance company entered patient information. Healthcare product information is selected for display based on information from at least one of these sources along with the process the healthcare provider has selected within healthcare provider's computerized workflow process. The sources may be accessed through a global communications network. The healthcare provider can select healthcare information from these of sources and can electronically annotate the healthcare information for a recipient. The healthcare information and the electronic annotation is merged into a information file and electronically send the merged information to the patient through a global communications network for display to a recipient.

Information displayed to a user can be customized based on the patient medical information, the healthcare provider information and the patient-entered data.

In one embodiment, a computer-implemented method of displaying targeted healthcare product information to a computer user comprises using stored medical information from a plurality of sources. Those sources may be a patient's medical history for a selected patient, healthcare provider information and prescription writing habits of a healthcare provider. The method associates the medical information from the at least one of the plurality of sources with stored healthcare advertisement information to select an advertisement for display to a user that is related to the at least one of the sources. The healthcare advertisement is then transmitted for electronically displaying to the user. Revenue can be provided to the healthcare provider based on the number of patients of the healthcare provider that visit a specified website. Revenue can also be provided to the healthcare provider for using the computer system.

In the present system and method, when a physician writes a prescription order that includes refills, those “refill options” may be electronically stored in a database and only a single prescription order is sent on to the selected pharmacy for fulfillment. When the time comes to refill the prescription, the patient, not the initial filling pharmacy, has control over those refill options. For example, the patient may elect to send the first refill order to a pharmacy near the patient's home, the second refill to a pharmacy near the patient's office, and the third refill to an Internet-based pharmacy. This allows the patient to shop for the greatest convenience and/or value for the refill prescriptions, rather than being tied to the pharmacy that filled the initial order. The computer-implemented method of managing prescription refills comprises entering a prescription into a computer program, if the prescription has at least one refill, storing by the computer program the at least one refill, transmitting by the computer program the at least one refill to a patient-selected pharmacy, updating the number of remaining refills and storing any remaining refills by the computer program, and repeating the process of transmitting refills until no refills remain. The refill is transmitted to a patient-selected pharmacy upon a request by the patient. The refill is transmitted to a patient-selected pharmacy prior to the patient using all of a current prescription.

The software programs incorporating these methods may be embodied on a computer-readable medium.

The above disclosed subject matter is to be considered illustrative, and not restrictive, and the appended claims are intended to cover all such modifications, enhancements, and other embodiments which fall within scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A computer-implemented method for integrating information into a medical workflow process, the method comprising:
receiving data associated with a patient;
initiating a computer search of information based on the received data associated with the patient;
receiving search results from the computer search of information; and
integrating the search results into the medical workflow process.

2. The method of claim 1, wherein integrating the search results comprises presenting at least a portion of the search results and the data associated with the patient in a combined view.

3. The method of claim 2, wherein the combined view is displayed on a portable computational device.

4. The method of claim 1, wherein the medical workflow process includes interface pages associated with at least one of history of present illness, medical history, review of systems, medication, physical examination, and test results.

5. The method of claim 1, wherein initiating the computer searching is performed in accordance with search rules.

6. The method of claim 5, wherein the search rules are associated with the step within the workflow.

7. The method of claim 5 wherein the search rules are associated with the type of data.

8. The method of claim 1 wherein initiating the computer search is performed asynchronously with the medical workflow process.

9. The method of claim 1, further comprising:
pre-fetching information associated with the search results.

10. The method of claim 1, further comprising:
performing a second search after additional data is gathered through the workflow process.

11. The method of claim 1, further comprising:
sorting the search results as additional data is gathered through the workflow process.

12. The method of claim 1, further comprising:
filtering the search results as additional data is gathered through the workflow process.

13. The method of claim 1, further comprising:
computing at least one probable diagnosis from the data associated with the patient.

14. The method of claim 13, wherein the at least one probable diagnosis is an input to the computer search.

15. The method of claim 1, further comprising:
integrating the search results into a composite query result.

16. The method of claim 1, the method further comprising:
mapping explicitly entered diagnosis terminology to corresponding MESH terminology for use in initiating the search.

17. The method of claim 1, wherein the step of integrating comprises adding links to information on a page associated with the workflow process.

18. The method of claim 1, wherein the step of integrating comprises integrating text into a page associated with the workflow process.

19. The method of claim 1, wherein the step of integrating comprises providing a message box in the workflow process.

20. The method of claim 1, wherein the step of integrating comprises providing a list of references on a page accessible during the workflow process.

21. The method of claim 1, wherein the step of initiating a search comprises querying remote databases.

22. The method of claim 21, wherein the remote database is associated with a government disease control entity.

23. The method of claim 1, wherein receiving data comprises gathering data from multiple input sources.

24. The method of claims 1, wherein the information comprises medical algorithms and step therapies.

25. The method of claim 1, wherein the search is initiated in accordance with user preferences.

26. The method of claim 1, wherein the search is initiated in accordance with domain-specific medical knowledge.

27. The method of claim 1, wherein the information comprises a clinical trial database.

28. The method of claim 1, wherein the search results comprise a treatment algorithm.

29. The method of claim 28, wherein the treatment algorithm is associated with the patient's payer.

30. The method of claim 1, wherein the information is input by different entities.

31. The method of claim 30, wherein one or more of the entities inputting the information pay to input information.

32. The method of claim 31, wherein the entities pay based on whether the search results include the entity's data.

33. The method of claim 31, wherein the entities pay based on whether the search result is selected.

34. The method of claim 31, wherein the entities pay based on whether a product associated with the entity is ordered for the patient.

35. The method of claim 1, wherein the information is stored in more than one data store.

36. The method of claim 35, wherein search input parameters associated with the computer search are operationally different for differing data stores.

37. The method of claim 1, wherein the data associated with the patient comprises data entered during the medical workflow process.

38. The method of claim 1, wherein the data associated with the patient is received from more than one user.

39. The method of claim 1, wherein a first user inputs the data associated with the patient and a second user observes the search results.

40. The method of claim 40, wherein the first user is the patient and the second user is a medical professional.

41. The method of claim 40, wherein the first user is a medical professional and the second user is a patient.

42. The method of claim 1, wherein receiving data associated with the patient comprises storing information in a patient's electronic medical record.

43. The method of claim 1, wherein receiving data associated with the patient occurs during one medical encounter and wherein, the method further comprises displaying the search results during a subsequent medical encounter.

44. The method of claim 1, wherein the search results comprise information about a medication associated with a patient condition and wherein the data associated with the patient comprises at least two of a patient's diagnosis, a patient's allergies, a patient's formulary, and a prescriber's prescribing history.

45. A system for processing information associated with patient medical data, the system comprising:
at least one user interface for receiving patient medical data;
a database storing data records associated with the patient medical data;
a server having access to the database;
a set of search rules accessible by the server, the server configured to initiate a search resulting in a search result based on the data records stored in the database and the set of search rules; and
a network interface accessible by the server, the server initiating the search and receiving the search result through the network interface.

46. The system of claim 45, wherein the at least one user interface is a wireless handheld data entry device.

47. The system of claim 45, wherein the search result is integrated into a medical workflow accessed through the at least one user interface.

48. The system of claim 45, the system further comprising:
a user preference for use in initiating the search.

49. The system of claim 45, the system further comprising:
an algorithm for determining at least one diagnosis.

50. The system of claim 45, the system further comprising:
a compilation of information referenced by the search.

51. The system of claim 50, wherein the compilation of information comprises treatments.

52. The system of claim 50, wherein the compilation of information comprises tests.

53. The system of claim 50, wherein the compilation of information comprises a clinical trial database.

54. The system of claim 50, wherein the compilation of information is associated with a government disease control entity.

55. The system of claim 45, wherein the search is initiated in accordance with domain-specific medical knowledge.

56. The system of claim 45, wherein the search result comprises a treatment algorithm.

57. The system of claim 56, wherein the treatment algorithm is associated with a patient's payer.

58. A system for receiving information associated with patient medical data, the system comprising:
at least one user interface for receiving patient medical data;
a database for storing records associated with the patient medical data;
a server coupled to the database; and
at least one healthcare data storage computer, the server configured to initiate a search of the at least one healthcare data storage computer based on the patient medical data to provide a search result.
